(19) United States
(12) Patent Application Publication
(10) Pub. No.: US 2004/0034576 A1
(43) Pub. Date: Feb. 19, 2004

(54) Design creation and manipulation systems, methods, and products

(76) Inventors: Mark W. Jones, LaGrange, GA (US); James C. Bridges, LaGrange, GA (US)

Correspondence Address: Daniel R. Alexander, Legal Department, M-495, PO Box 1926, Spartanburg, SC, 29304, US

(21) Appl. No.: 10/460,839

(22) Filed: Jun. 12, 2003

Related U.S. Application Data
(60) Provisional application No. 60/388,833, filed on Jun. 14, 2002.

(51) Int. Cl. G06F 17/60

(52) U.S. Cl. 705/27

(57) ABSTRACT

An Internet-based system and/or method for enabling users to review and revise potential floor covering designs before products utilizing such designs are purchased. The system and/or method permit such users to review and revise selected designs.

CROSS-REFERENCE TO RELATED APPLICATIONS

This application claims priority to and benefit of U.S. Provisional Patent Application No. 60/388,833, filed Jun. 14, 2002, the contents of which are hereby incorporated by reference in their entirety as if fully set forth herein.

### FIELD OF THE INVENTION

This invention relates to systems for the evaluation, creation, manipulation, ordering, and/or marketing of proposed surface covering, wall covering or floor covering designs, patterns, colors, products, etc. More specifically, the invention relates to systems and methods whereby a number of users or subscribers or customers such as architectural and design professionals may review, create, recolor, manipulate, and the like designs and/or products and order samples and/or products from the manufacturer to reduce the time involved, to enhance and facilitate the selecting, modifying, coloring, and ordering of such products, to enable the purchaser or user to be involved in the process and be satisfied with the products, to produce samples and/or products, acceptable to the customer, to provide for personalized, customized, and/or one of a kind designs, samples and or products and the like.

The present invention also relates to systems, tools and/or methods especially computer based systems, tools and/or methods for the evaluation of patterns or designs such as for patterned broadloom carpet and carpet tiles. More particularly, at least one embodiment of the present invention is directed to a system, tool and/or method for presenting and manipulating a plurality of simulated designs or patterns corresponding to designs or patterns on carpeting, carpet tiles, or other floor covering or surface covering products. The simulated designs or patterns may be manipulated to change color, scale, orientation, and to simulate various surface designs, layouts or arrangements of potential interest, for example, prior to ordering samples and/or the actual purchase or installation of the floor covering. The system, tool and/or method provide relatively easy manipulation and retooling of the simulated designs or patterns by a user of the system.

### BACKGROUND

Surface coverings such as wall coverings and floor coverings including carpet, broadloom carpet, area rugs, runners, mats, carpet tiles and the like are features of substantial importance in a building environment. The selection and purchase of floor covering materials for a commercial environment typically represents a fairly substantial investment. Decisions for large-scale projects are typically made by professionals within the architectural and design community. Such professionals coordinate floor covering designs with other elements of the building project to yield an aesthetically pleasing environment. Architectural and design professionals thus represent an important link between the manufacturer of the floor covering materials and the final user.

It has long been recognized that certain floor covering designs are more readily accepted and appreciated by the public than are others. It has also long been recognized that such acceptance and long-term appreciation may be reinforced by positive marketing efforts directed towards particular designs. Such marketing efforts are typically carried out by the manufacturer of the floor covering material and may be directed to both professionals within the architectural and design communities as well as to the public at large. Thus, each manufacturer provides marketing support to its own designs thereby encouraging the selection of those designs by professionals within the architectural and design communities while simultaneously providing a positive reinforcement of the desirability of such designs within the minds of the ultimate user.

Heretofore, the manufacturer would typically develop a number of different designs for floor covering materials and would independently identify those designs believed to have the highest likelihood of realizing commercial success. Those designs identified as having the greatest commercial potential would thereafter be the focus of substantial marketing efforts while those designs considered to have less potential would typically receive a correspondingly reduced level of marketing attention. In this manner, it was believed that those designs most likely to be used would be promoted to the fullest extent possible. While this mechanism for the allocation of marketing resources has been generally successful, it has been largely dependent upon the independent judgment of individuals within the manufacturing organization and has generally not made substantial use of input from the architectural and design communities at large. Thus, in some instances designs which were believed to be highly attractive to a broad cross section of the population were ultimately determined to have a relatively narrow appeal which could not be overcome by positive marketing efforts. Likewise, in some instances it has been determined that designs which were initially perceived as having relatively limited use were found to be widely desirable. In such instances, marketing resources were often times already committed to other designs having less commercial potential.

Conventional evaluation of floor covering or flooring products such as carpeting, carpet tiles and area rugs involves a purchaser viewing samples (such as swatches), actual products, brochures, print outs, or other advertising showing products and patterns of interest and attempting to formulate a mental impression of how the floor covering will ultimately appear in an installed state within the final area of use (home, office, room, etc.).

This process may be further complicated in that patterns or designs may be rotated 90, 180, or 270 degrees relative to the usual orientation to create a different appearance while nonetheless using the same design or pattern.

It is also possible to create different looks by using different designs, patterns, or colors in an outfield and/or border as compared to a broadloom field. Further, it is also possible to incorporate an inlay and to use different surface designs in a single installation such that different designs are present at different locations within the installation. Such multi-patterned or multi-design installations are difficult to visualize.

While a designer or salesperson may print out different designs, patterns, colors, layouts, and the like, it may still be difficult for a customer to visualize the coordinated arrangement or layout of floor covering prior to actual installation. While the use of physical samples of the floor covering material is generally useful, it may be difficult to visualize various combinations of different surface designs and/or placement orientations from such samples. Moreover, if multiple designs are contemplated, it may be time consuming and expensive to produce actual product samples for each contemplated design. Further, numerous actual 36 inch×36 inch full size carpet tile or carpet samples may be heavy, bulky and cumbersome to transport to or from the customer and difficult for customers to manipulate. Finally, typical floor covering products or samples are not configured for mounting on a common support surface for manipulation and evaluation of different designs and/or orientations and/or combinations.

Still further, pattern carpet or carpet tile having unique designs, patterns, color combinations, textures, and/or the like provides for aesthetically pleasing flooring, but as contrasted to solid color carpet provides a challenge in visualizing how the pattern carpet or carpet tile will look installed in a room, home, office, or the like. For example, Milliken & Company of LaGrange, Ga. produces jet dyed pattern carpet and carpet tile having aesthetically pleasing unique designs, colors, textures, and the like.

Hence, there is a need for an improved system, tool, and/or method for evaluating potential floor covering pattern arrangements or installations prior to the floor covering samples and/or products actually being ordered, purchased or installed and/or for producing custom, personalized, or one of a kind samples and/or products.

### SUMMARY OF THE INVENTION

At least one embodiment of the present invention provides advantages and alternatives over the prior art by providing a computer and/or Internet-based system and method for enabling users or customers such as professionals within the architectural and design communities to review, manipulate, revise, and/or create potential surface covering, wall covering or floor covering designs, patterns or colors before products utilizing such designs are purchased. The system and method permit such professionals (users or subscribers) to communicate to the manufacturer of the floor covering material an order for a sample and/or to work in real time on-line with a designer or agent of the manufacturer. The information from the customers or users may thereafter be utilized by the manufacturer to promote those designs which are identified by the architectural and design professionals as being most desirable, to update the design database to include the new custom, personalized and/or one-of-a-kind designs, to produce samples and/or products, and the like.

According to one exemplary embodiment, users or customers such as pre-qualified subscribing professionals within the architectural and design communities are informed of an on-line design URL or web site maintained by the manufacturer of the floor covering material. Through that site, the subscribing professionals within the architectural and design communities may access images of the potential new designs and immediately evaluate, review, select, manipulate, recolor, and/or the like each individual design. The results of the review by the subscribing professionals is sent to the manufacturer of the floor covering material. The manufacturer may thereafter select certain of those designs to be the subject of comprehensive future marketing efforts while other designs may be identified as warranting more modest marketing efforts or potentially complete abandonment. The subscribing professionals may also connect in real time with a floor covering designer or salesperson and work together on-line to review, evaluate, manipulate, create, and order samples and/or products. The images provided to the subscribing professionals may include electronic links to an ordering site maintained by the manufacturer of the floor covering material to permit the acquisition of a physical sample and/or product if desired. The present invention thus provides an Internet-based method and Web site system to provide the highly efficient evaluation, review, manipulation, revision, creation and/or ordering of a large number of floor covering designs by a significant number of qualified professionals thereby providing a large number of meaningful opportunities to create and sell products. Also, the data obtained from this sample population of knowledgeable individuals may be used to identify designs worthy of significant subsequent marketing effort.

The subscribers or users get the benefit of being able to use the system at their convenience, to review, evaluate, manipulate, revise, and/or create designs, patterns, colors, layouts, and to order samples and/or products incorporating the designs. Also, if sufficient subscribers order products based on their use of the system, then this may further reduce the need for staffing and/or additional marketing efforts.

At least one embodiment of the present invention provides advantages and/or alternatives over the prior art by providing a system, method and/or tool whereby a user such as a prospective purchaser of floor coverings or other surface coverings may engage in the contemporaneous manipulation and evaluation of various designs, patterns, colors, combinations and/or placement orientations for floor covering elements or products prior to ordering samples and/or actual purchase or installation.

According to one embodiment of the present invention, a computer system or tool for simulating a floor covering design, pattern, arrangement or installation is provided. The computer system includes a personal computer (including a processor, a display or monitor and a user interface (keyboard and/or a mouse)), a lap top computer, or other video terminal having access to a database of a multiplicity of patterned simulated floor covering products substantially corresponding to commercially available carpet or other floor covering such as runners, borders, outfill, mats, rugs, carpet tiles, or the like to be used in the proposed installation thereby substantially simulating such floor covering. The manipulatable simulated elements include surface designs, patterns, colors, textures, and/or the like substantially corresponding to available surface designs of floor covering for potential use in the actual installation. The size and shape of the simulated elements substantially correspond to the design or pattern on and the size and shape of the actual floor covering in terms of relative size and shape such that the simulated elements appear as substantially complete but reduced versions of the patterns across the actual floor covering.

The computer system also includes software, tools, plug-ins, and/or the like that allow the user to selectively manipulate and view the simulated design elements in selected colors, arrangements or orientations on the CRT display or computer monitor. The simulated elements may thereby be manipulated, revised, recolored, scaled, rotated, and viewed in an arrangement or layout substantially corresponding to proposed arrangements of floor covering across an underlying flooring surface in the proposed floor covering installation.

According to another aspect of the invention, an automated system, tool or method of manipulating simulated floor covering elements such as carpet incorporating designs substantially corresponding to designs present across floor covering of possible interest to a purchaser is provided. The simulated floor covering designs correspond substantially to an available surface design for carpet, carpet tile, or other floor covering product. The simulated floor covering designs can be viewed in top view or perspective view (such as in a room scene) so as to simulate disposition of floor covering across a flooring surface. The simulated floor covering designs may be manipulated to yield various alternative designs, colors, scales, orientations, or arrangements for substantially contemporaneous evaluation of multiple prospective designs and/or installation arrangements. The selected designs or layouts may be viewed, edited, stored, and/or printed out. Also, once a user has selected the desired floor covering design or combination, the floor covering samples and/or products may be ordered.

According to another aspect of the present invention, a method of generating a simulated surface covering or floor covering installation is provided. In accordance with the method, one or more surface designs or patterns corresponding substantially to surface designs or patterns for available floor covering products are provided as manipulatable simulated designs such that each simulated design substantially corresponds to a patterned carpet, carpet tile or other floor covering product of interest to a user.

### BRIEF DESCRIPTION OF THE DRAWINGS

These and other features and advantages of the invention will now be described with reference to the drawings of certain potentially preferred embodiments, practices and procedures which constitute a part of this specification and which are intended to illustrate and not to limit the invention, and in which:

FIG. 1 is a high-level architectural drawing illustrating the primary components of a Web-based system according to an exemplary embodiment of the present invention;

FIG. 2 is a schematic process or flow diagram of an exemplary conventional process for selecting and ordering samples;

FIG. 3 is a schematic process or flow diagram of an exemplary system, method or process in accordance with one embodiment of the present invention;

FIGS. 4-106 are exemplary screen displays illustrating the system, method, or process in accordance with one embodiment or example of the present invention; and

FIGS. 107-108 are top view representations of an exemplary product produced in accordance with one embodiment or example of the present invention.

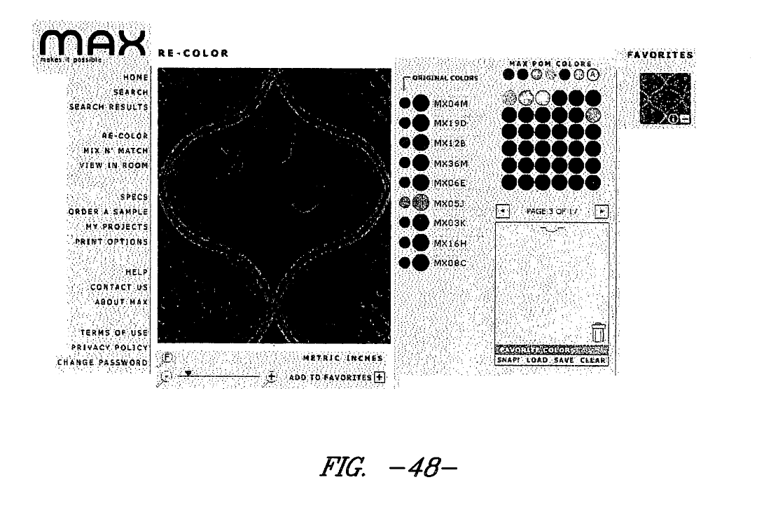

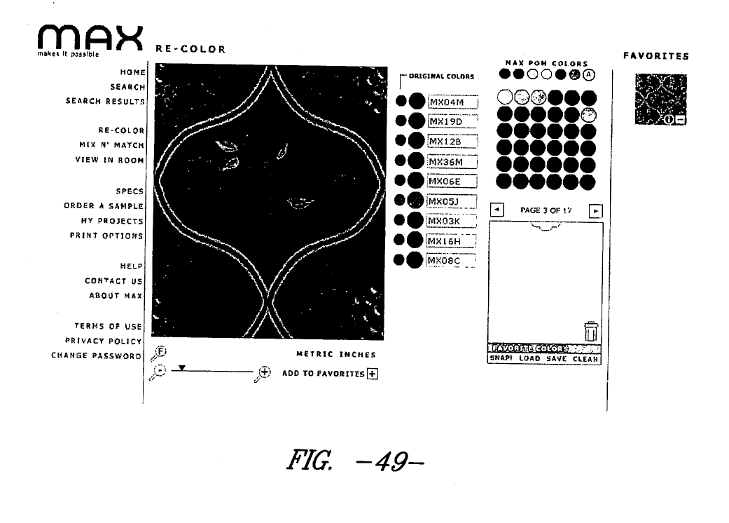

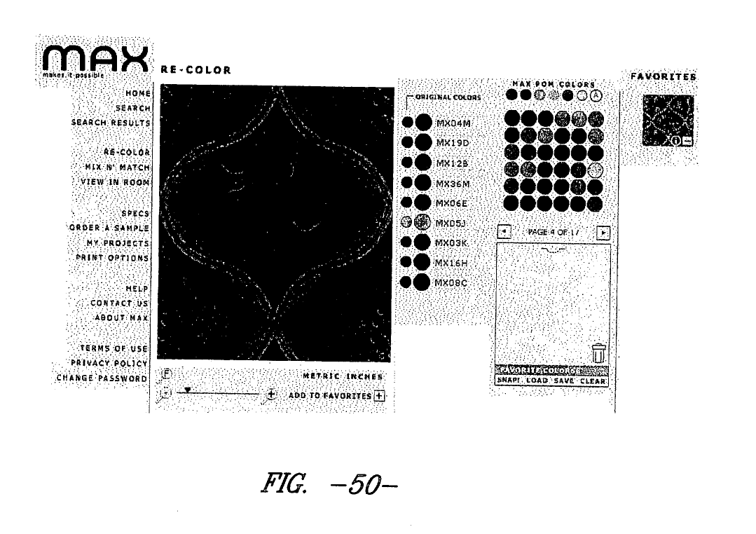

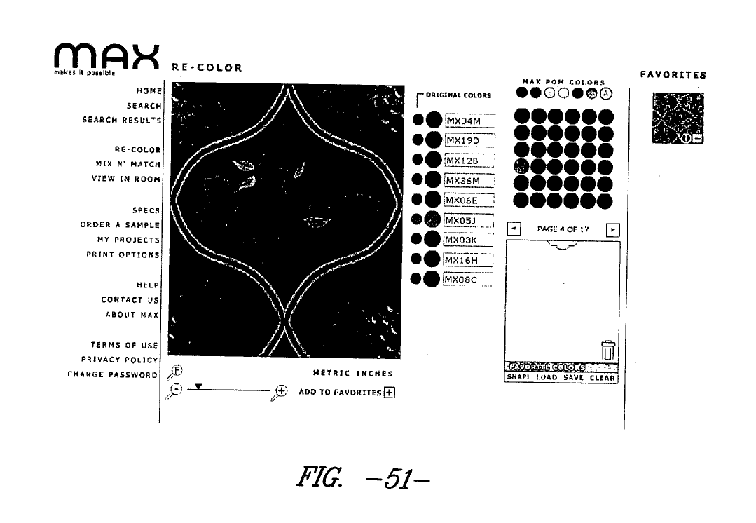

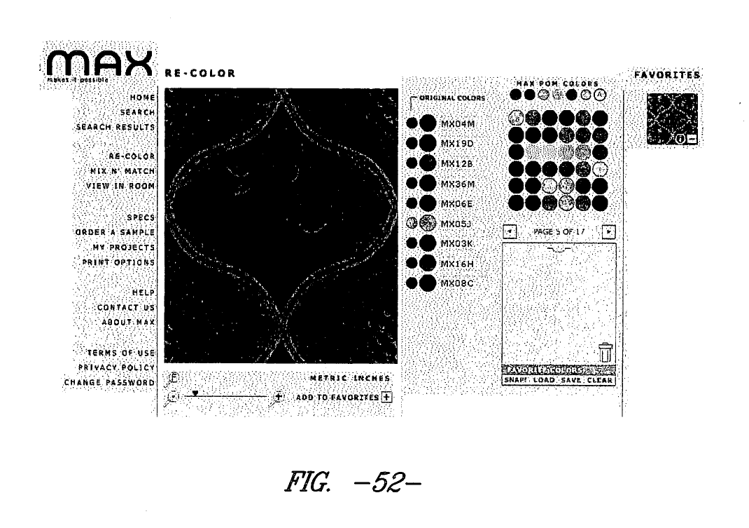

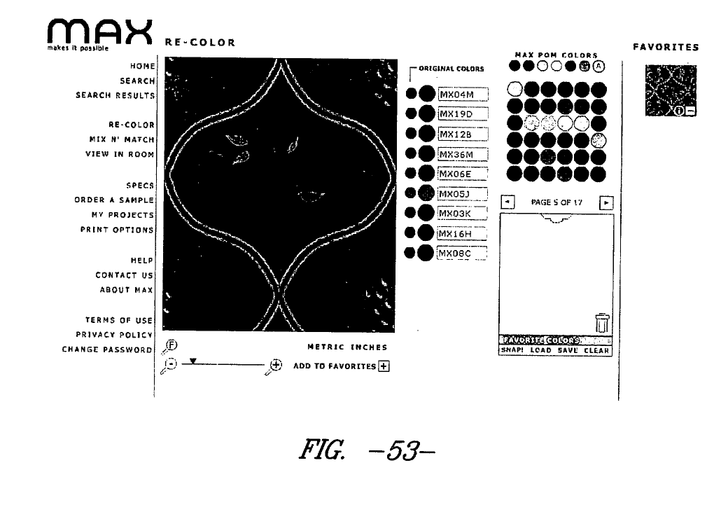

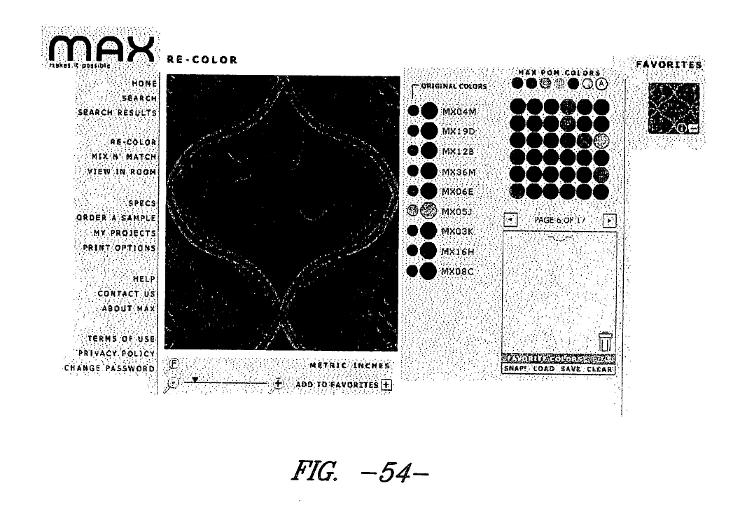

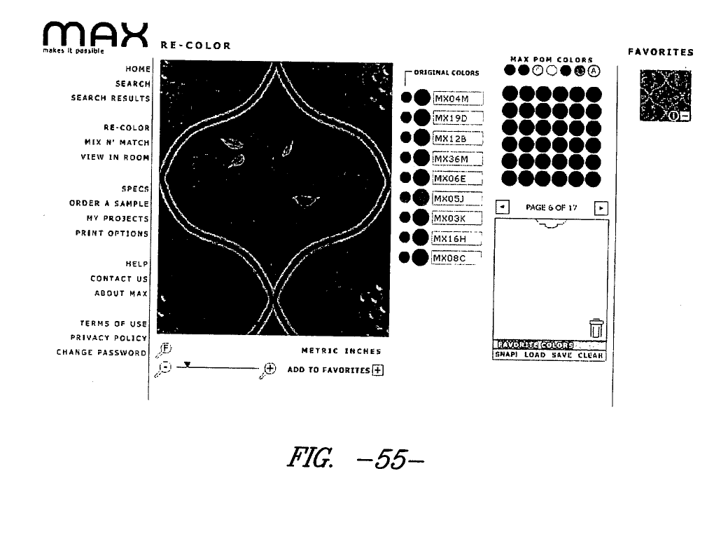

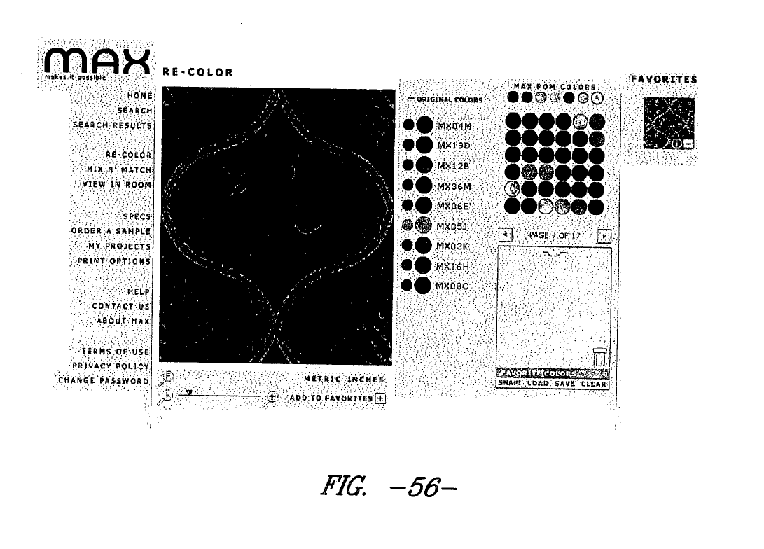

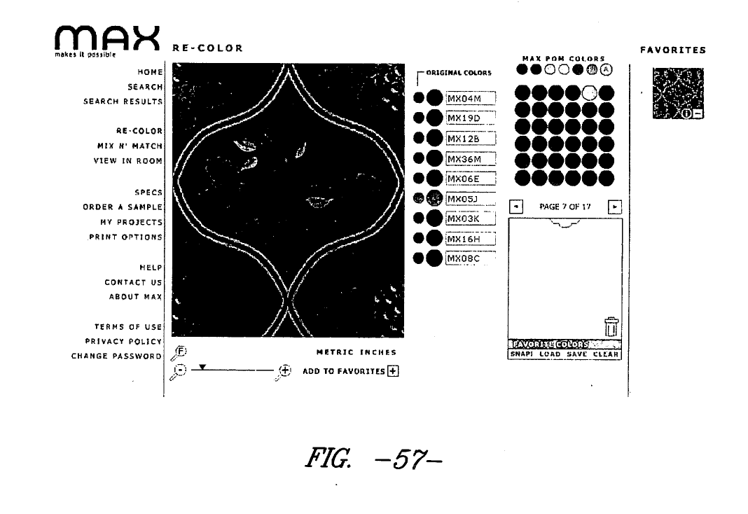

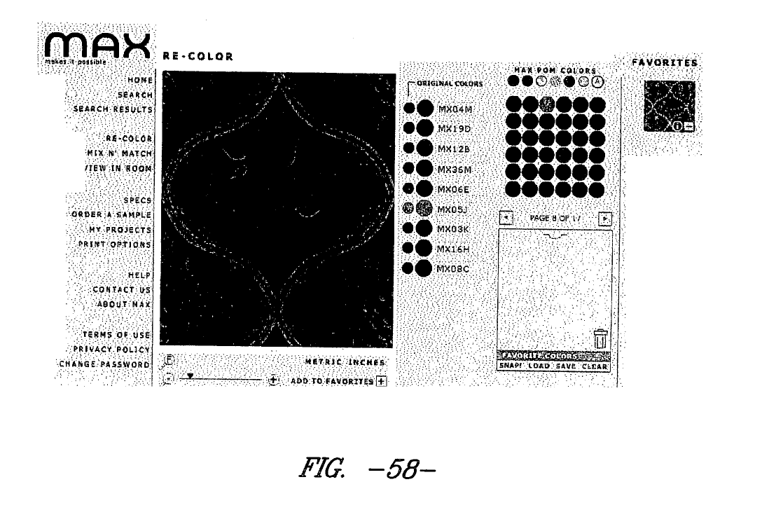

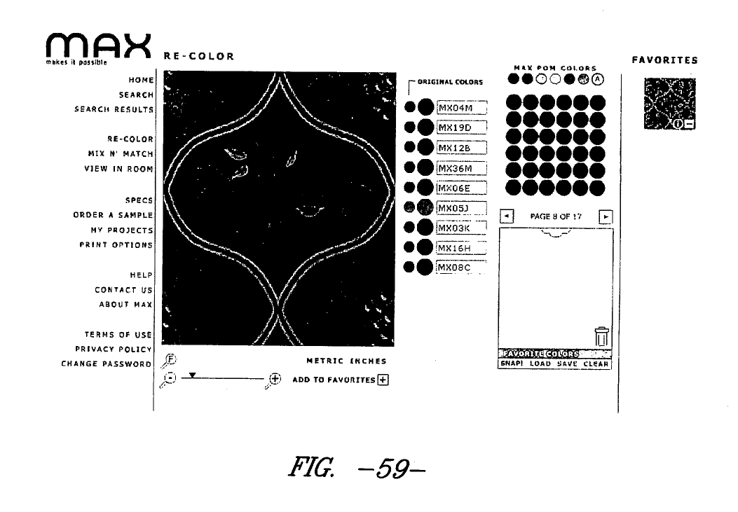

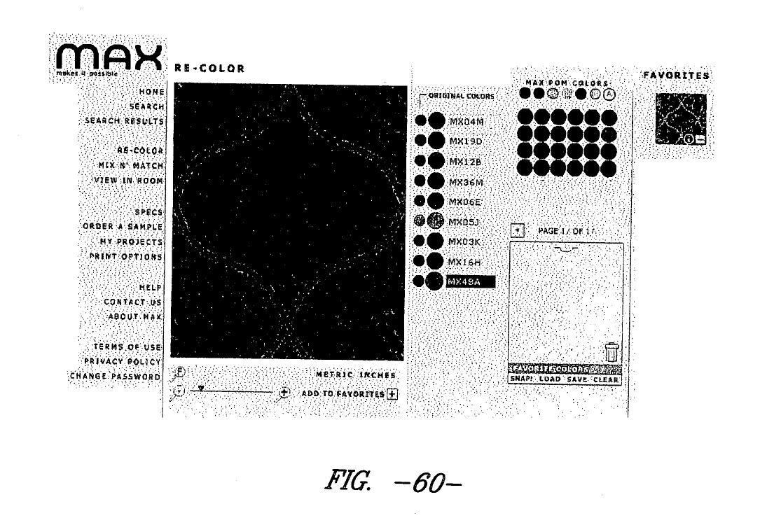

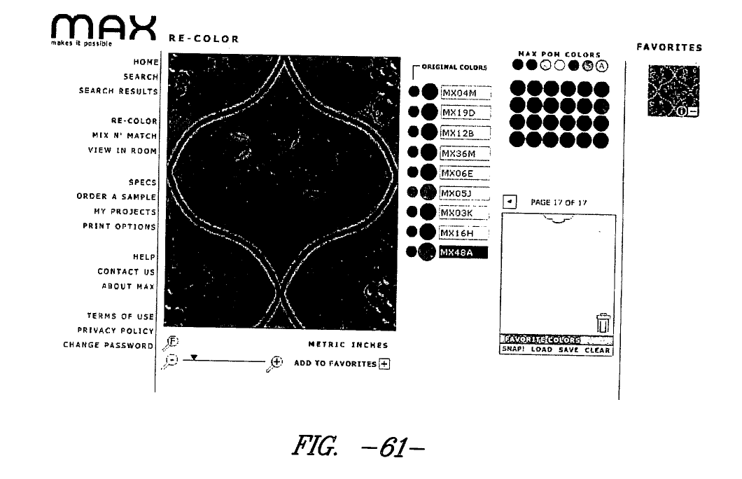

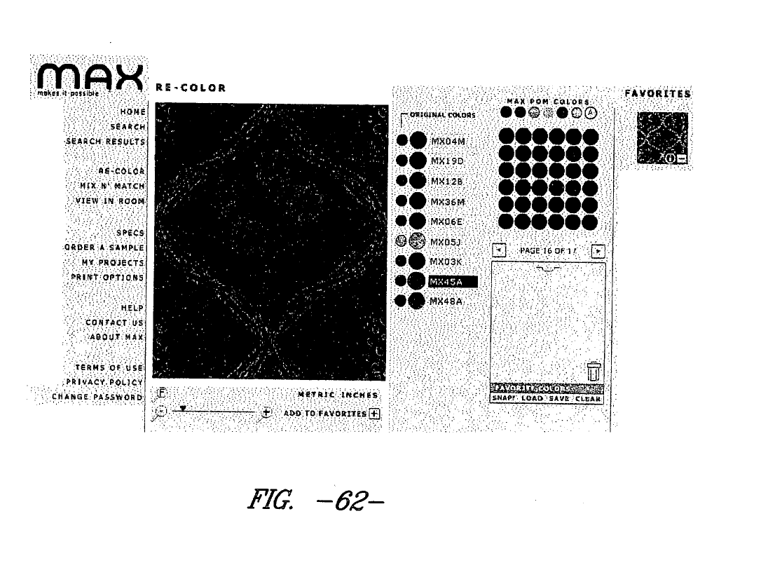

FIGS. 5, 9, 12, 16, 28, 31, 33, 35, 38, 41, 43, 45, 47, 49, 51, 53, 55, 57, 59, 61, 63, 75, 67, 69, 72, 74, 76, 79, 81, 83, 86, 90, 94, 97, 104, and 108 are respective black and white copies of color FIGS. 4, 8, 11,15, 27, 30, 32, 34, 37, 40, 42, 44, 46, 48, 50, 52, 54, 56, 58, 60, 62, 64, 66, 68, 71, 73, 75, 78, 80, 82, 85, 89, 93, 96, 103, and 107.

While the invention has been illustrated and broadly described above and will hereinafter be described in connection with certain potentially preferred embodiments and practices, it is to be understood that in no event is the invention limited to such illustrated and described embodiments and practices. On the contrary, it is intended that the present invention shall extend to all alternatives and modifications as my embrace the general principles of this invention within the true spirit and scope thereof.

### DETAILED DESCRIPTION OF THE PREFERRED EMBODIMENTS

To facilitate a complete understanding of the invention, the following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

Hyperlink. A navigational link from one document to another, or from one portion (or component) of a document to another. Typically, a hyperlink is displayed as a highlighted word or phrase that can be selected by clicking on it using a mouse to jump to the associated document or documented portion.

Internet. A collection of interconnected (public and/or private) networks that are linked together by a set of standard protocols (such as TCP/IP, HTTP and HTTPS) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP or HTTPS, and the Web pages are encoded using HTML. However, the terms “Web” and “World Wide Web” are intended to encompass present and future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “MILLIKEN.COM,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (HyperText Markup Language). A standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”).

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET<URL>, causes the server to return the document or file located at the specified URL. HTTPS (HyperText Transport Protocol Secured) is used for access to a secured server. HTTPS uses SSL (Secured Sockets Layer) to encrypt the data and may provide user authentication.

URL (Uniform Resource Locator). A unique address which fully specifies the location of a file or other resource on the Internet. The general format of a URL is protocol://machine address:port/path/filename. The port specification is optional, and if none is entered by the user, the browser defaults to the standard port of whatever service is specified as the protocol.

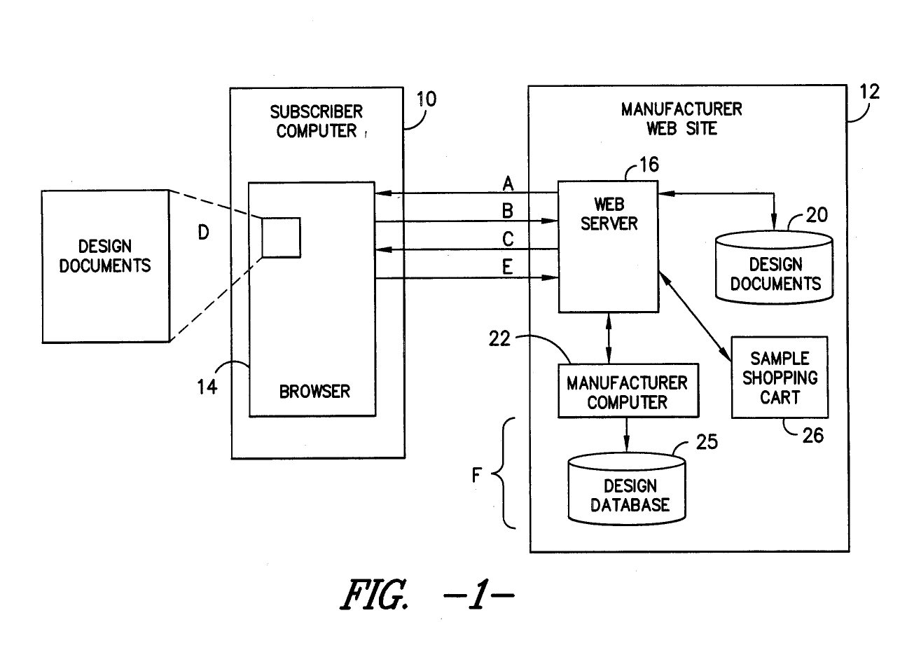

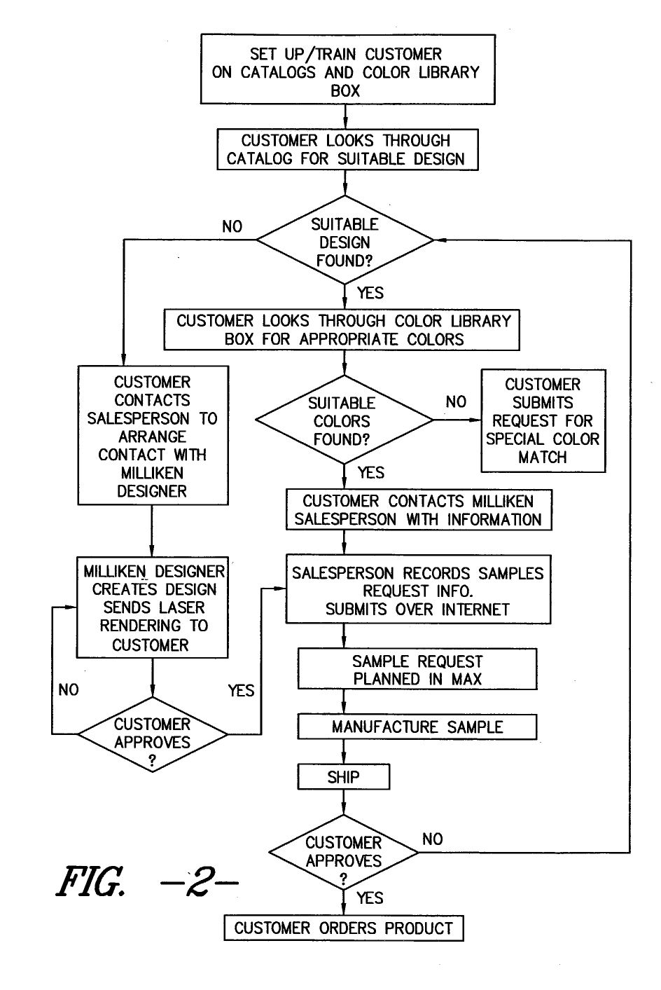

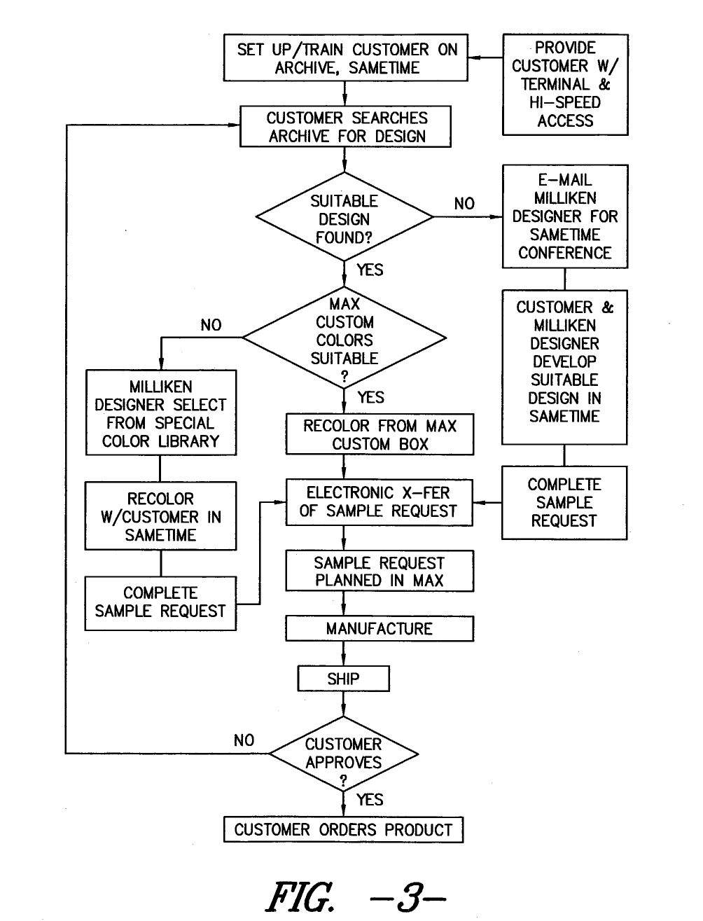

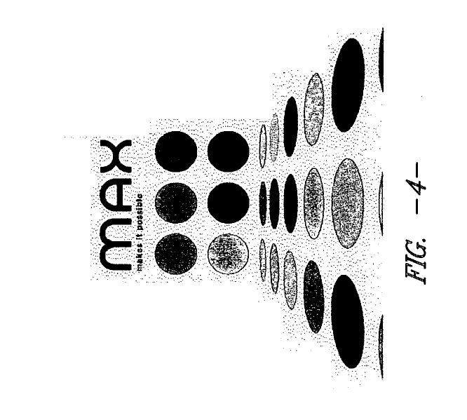

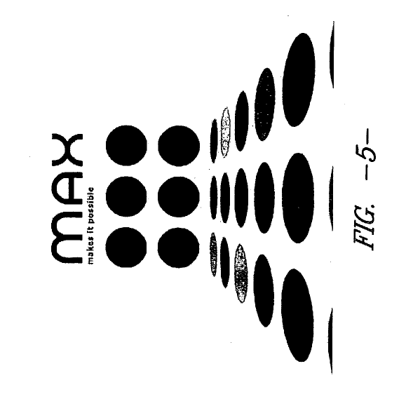

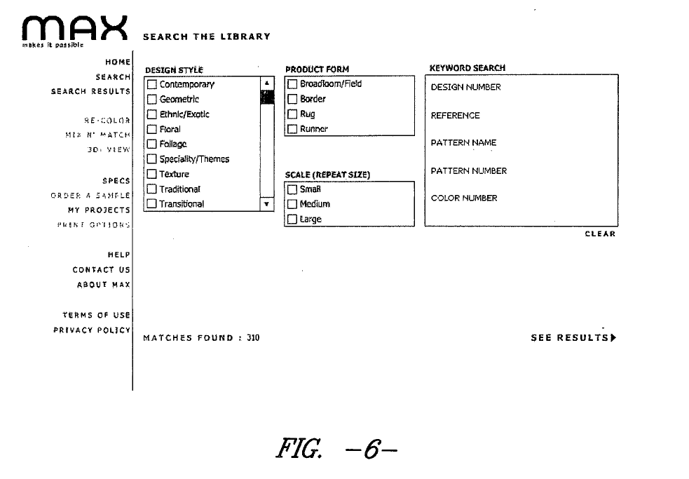

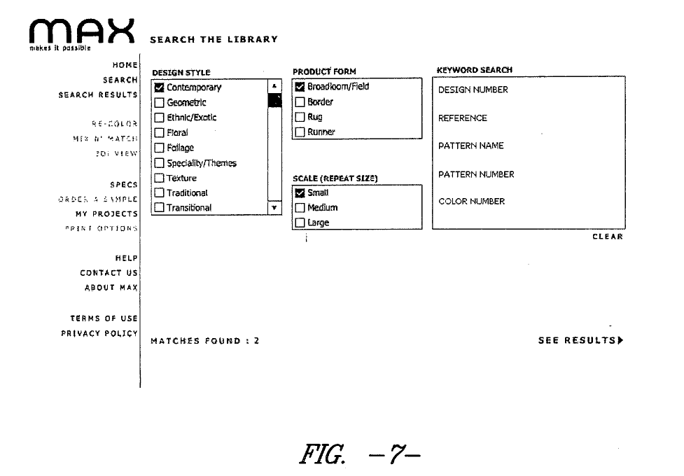

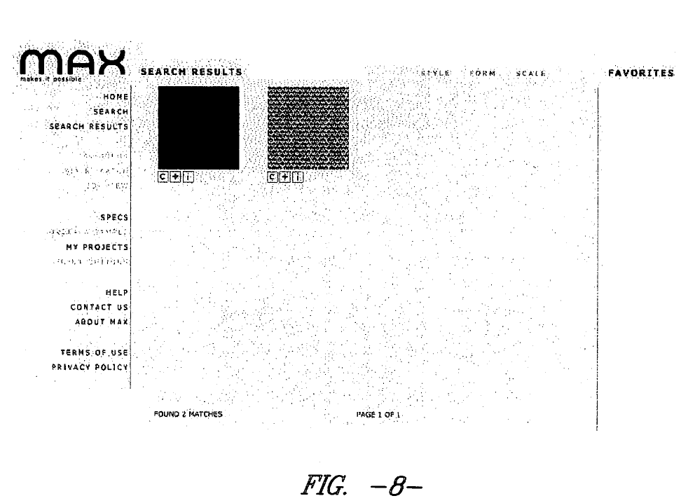

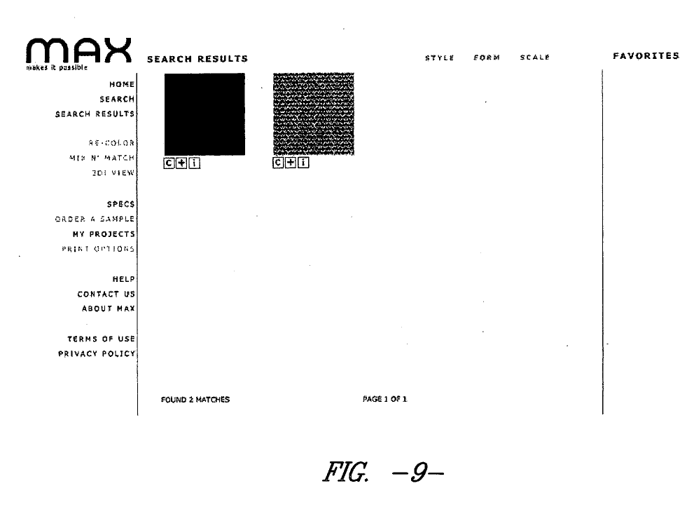

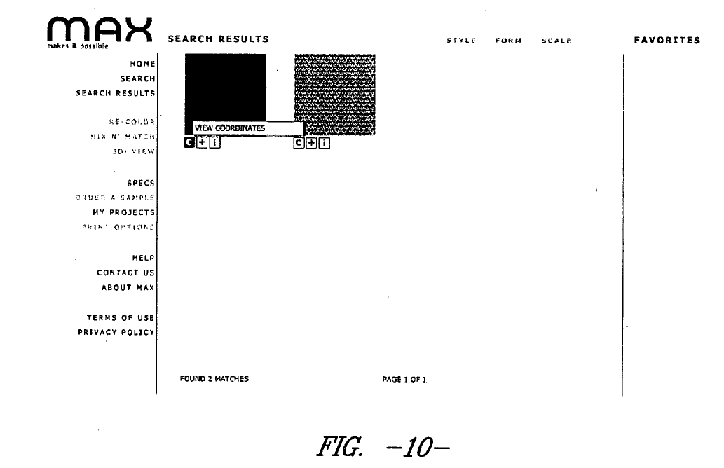

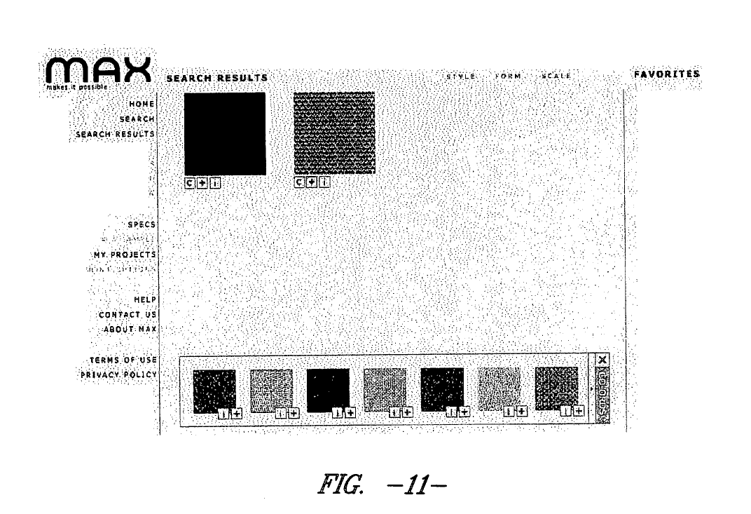

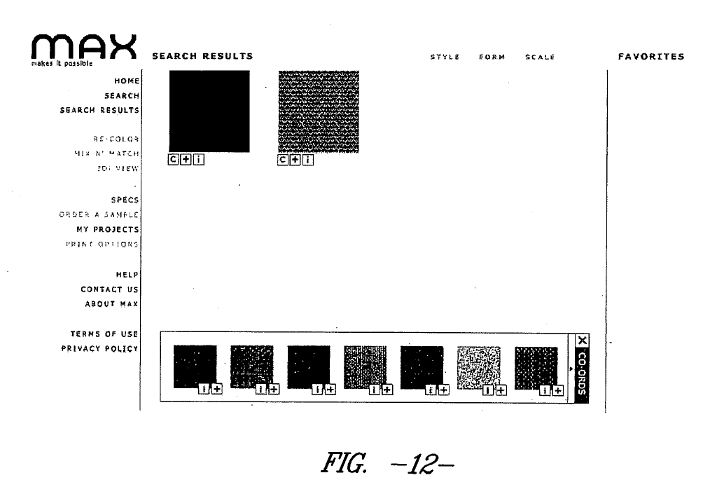

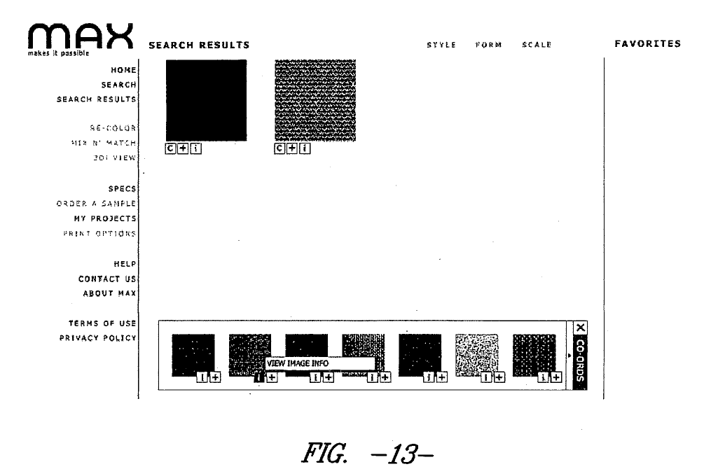

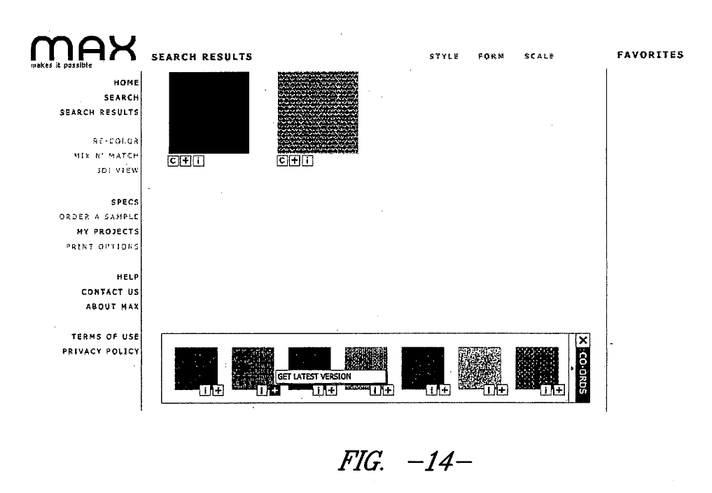

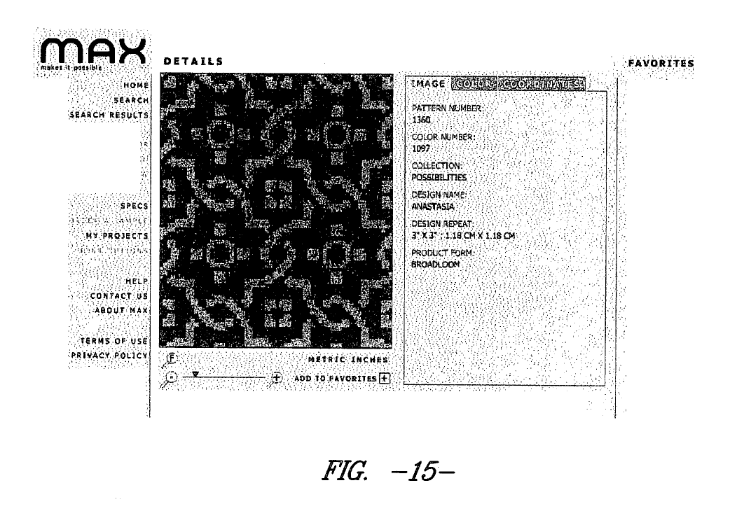

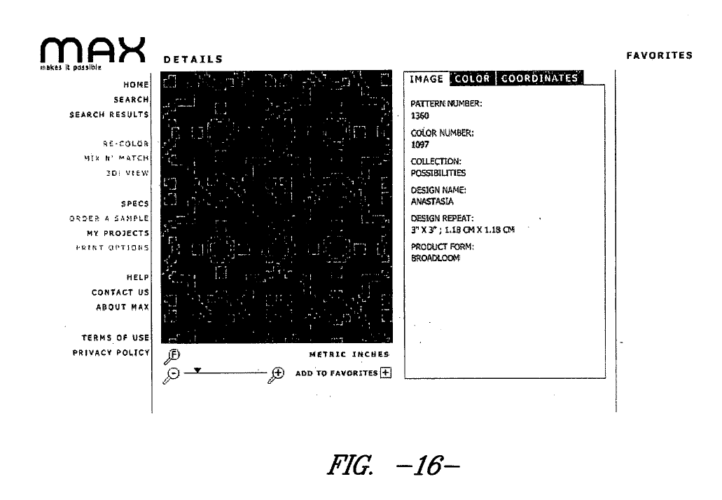

Turning now to the figures, FIG. 1 illustrates the general architecture of an exemplary design system that operates in accordance with at least one embodiment of the present invention. The system includes a subscriber or user computer 10 linked via the Internet to a manufacturer Web site 12. The subscriber computer 10 may be any type of appropriate computing device that allows, for example, a pre-qualified user (i.e. “subscriber”) to interactively browse Web sites on the World Wide Web via a Web browser 14. By way of example only, the subscriber computer 10 may be a personal computer (PC) that runs a Windows based operating system. The Web browser 14 may be any suitable browser including, by way of example only, Microsoft Internet Explorer or Netscape Navigator.

The manufacturer Web site 12 is a multifunctional site that provides various functionality to allow users or pre-qualified subscribers such as professionals within the architectural and design communities to view surface covering, wall covering or floor covering designs, patterns, colors, etc. in printable format, to review, revise, customize, manipulate, recolor, rescale, rotate, select, save, and/or comment on designs and to order samples or products incorporating such designs while on-line. Typically, this site will be operated by the manufacturer of the surface covering, wall covering or floor covering products or materials or other business that handles the development and marketing of new product designs.

As illustrated, the manufacturer Web site 12 incorporates a Web server 16 with access to a database or catalog of design documents 20 preferably in HTML format which have been identified by the manufacturer for presentation to qualified subscribers. The design documents 20 may be requested, retrieved, and reviewed by subscribers via the Web browser 14. Information exchange between the subscriber computer 10 and the manufacturer web site is preferably carried out as a series of HTTP messages. As will be discussed further hereinafter, the design documents 20 are preferably in HTML format and include a printable display of new floor covering design as well as other information related to the design or product and embedded links to other documents or addresses of interest. By way of example, the design documents also may include links to information or ordering sites at which a subscriber may request the preparation and delivery of a physical sample and/or products incorporating an identified design. As will be appreciated, the manufacturer Web site 12 is preferably multi-functional and is controlled by a computer or server 22 running various software so as to provide a number of services such as contact information, product care data, account information, and the like which are not illustrated and described in reference to the present invention. Thus, it is to be understood that the manufacturer Web site 12 is in no way limited to such elements as are particularly illustrated and described in relation to the present invention.

As illustrated in FIG. 1 upon the approval or pre-qualification of a user or subscriber, a message is sent to the pre-qualified subscriber. The message is preferably in the form of an E-mail message including a link back to the appropriate URL address within the manufacturer Web site 12. According to one potentially preferred practice, selected designs are made available for the particular user.

Once the message is received by the subscriber, the subscriber may thereafter utilize the internal links within the message to request delivery of the design documents 20 incorporating printable images of the various designs. Such design documents are preferably communicated back to the requesting subscriber in a PDF format which may be viewed by the subscriber utilizing image display software such as Adobe Acrobat Reader, Flash, or the like. The subscriber may utilize the design documents to print record copies of the designs for future reference. Preferably such printing may be carried out by use of embedded print commands within portions of the design documents themselves.

Aside from the ability of the subscriber to view designs and to print record copies of such designs for future use, the present invention also contemplates that the subscriber may select, review, manipulate, revise, customize, save, and the like one or more of the designs. According to one potentially preferred practice, the subscriber is able to recolor, save, and order samples or product of one or more designs. This information is then communicated back to the manufacturer web site 12.

According to another aspect of the present invention, it is contemplated that the subscriber may be provided with the opportunity to order a physical sample and/or product incorporating a standard or customized design which may be of interest to that subscriber. According to a first embodiment of the invention, it is contemplated that such samples may be ordered via direct contact between the subscriber and the manufacturer. Accordingly, it is contemplated that the design documents communicated to the subscriber will preferably include a screen display depicting an arrangement of the various designs in association with particular design designations which may be used when contacting the manufacturer. For example, by contacting the manufacturer and identifying the design tape number and version of the sample of interest, a physical sample and/or product may be obtained.

According to another embodiment of the invention, it is also contemplated that the subscriber may order a physical sample on-line. By way of example only, it is contemplated that such ordering may be carried out by means of a linking button 24 on the display screen corresponding to each discrete design under evaluation. In operation, the activation of such a linking button will direct the subscriber to a sample and/or product shopping cart program 26 at which an order may be placed for a physical sample and/or product of the particular design of interest. The utilization of such on-line ordering of a physical sample and/or product has the potential benefit of avoiding the necessity of personal interaction between the subscriber and the manufacturer to obtain a sample or to order product.

In accordance with one particular embodiment, customers are provided a Design Computer with, Internet access for the purpose of selecting carpet for a project. The customer can access the Carpet Design Archive via the Internet. The customer then can search the database using a variety of criteria. After selecting designs, the customer can recolor them real time on their screen. The system also allows the customer to have a Carpet Designer to view the process in real time (for example, using Sametime) with them in a collaborative effort. Once designs and colors are selected, the customer can order samples electronically from the program. Sample requests flow directly to a queue for planning, manufacture, and direct ship to the customer.

In accordance with at least one embodiment, the present invention reduces the cycle time for developing (selecting, modifying, coloring), ordering and producing an acceptable customer carpet sample, shortens the cycle time from design conception to sample delivery, simplifies the design selection process through a large, searchable database of designs, reduces the need for lengthy and costly custom design, allows real time, on-line collaboration between customer and designer, and/or makes it easy to place colors in carpet designs.

With reference again to FIG. 1, and in accordance with one particular embodiment, A, B, C, D, E, and F in FIG. 1 relate to:

A—manufacturer sends message to subscriber.

B—subscriber accesses web site and requests one or more designs, information, and the like.

C—manufacturer provides the requested designs, information, etc. to subscriber.

D—subscriber reviews, revises, customizes, recolors, rescales, rotates, places in room scene, comments on, saves, and/or selects one or more designs.

E—subscriber orders sample and/or product and sends design information, comments, etc. to manufacturer.

F—manufacturer receives order, produces samples and/or products, such as by jet dye printing, graphic tufting or the like, saves new design to design archive or database, tracks designs ordered, and the like.

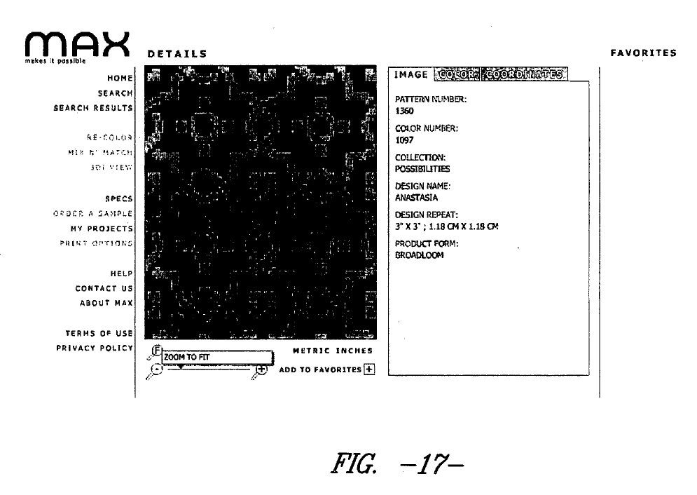

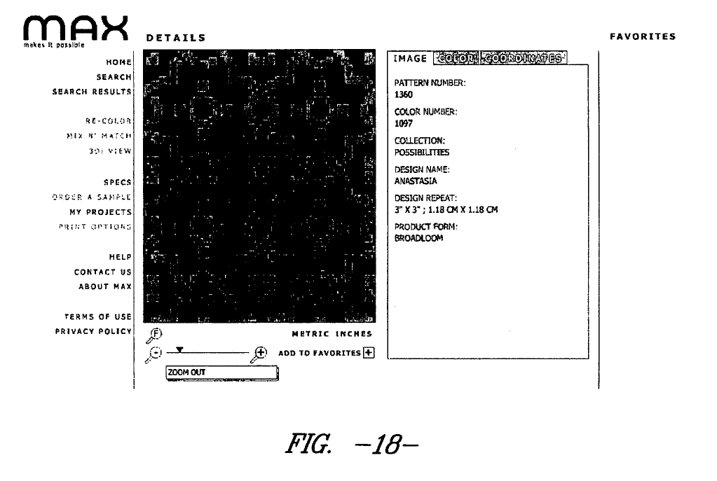

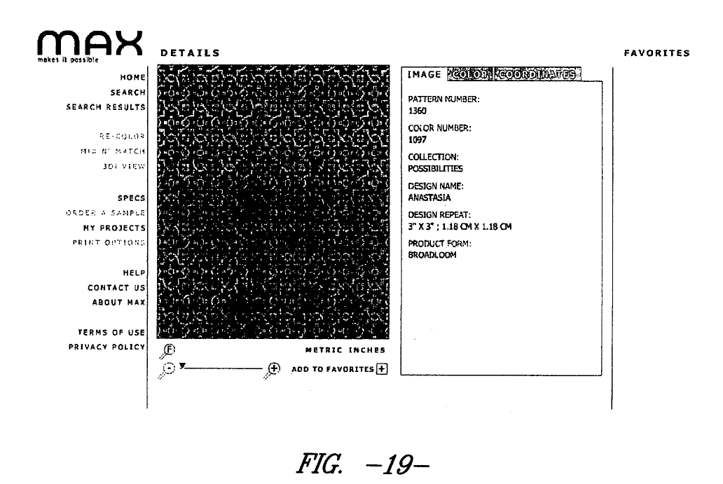

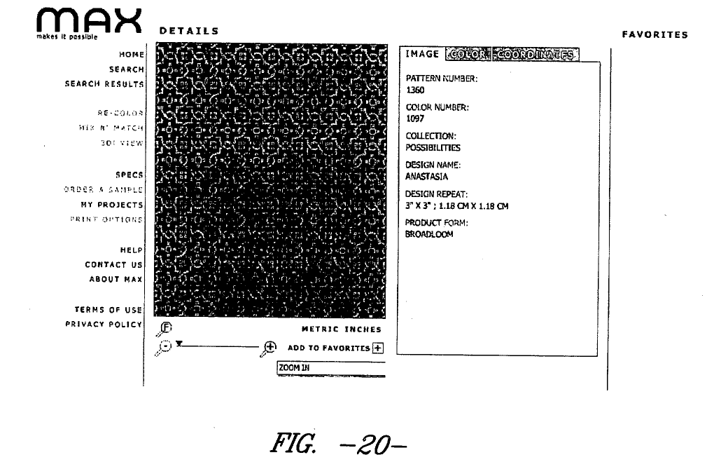

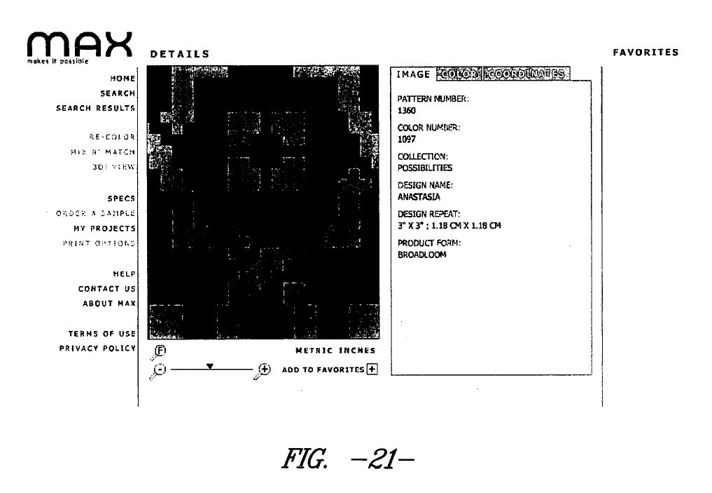

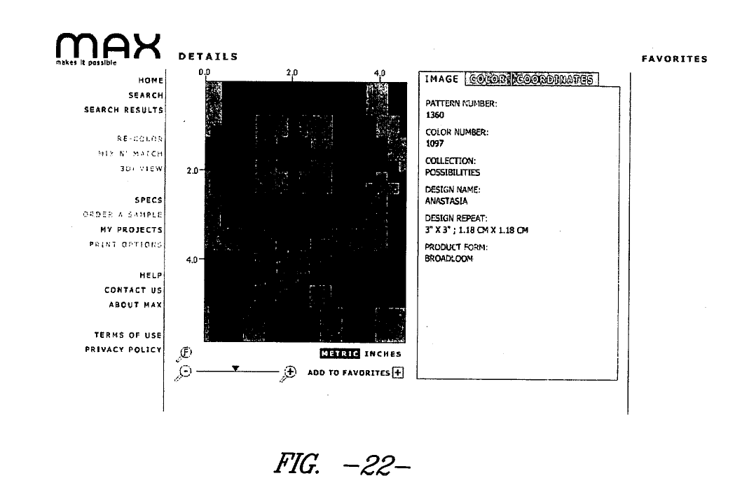

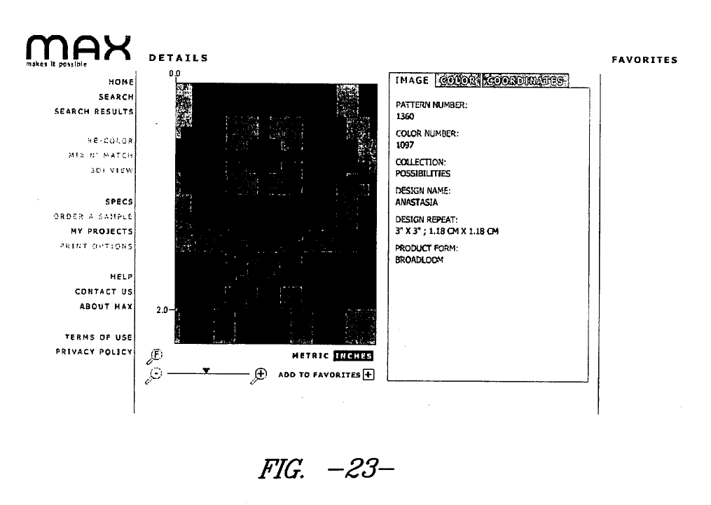

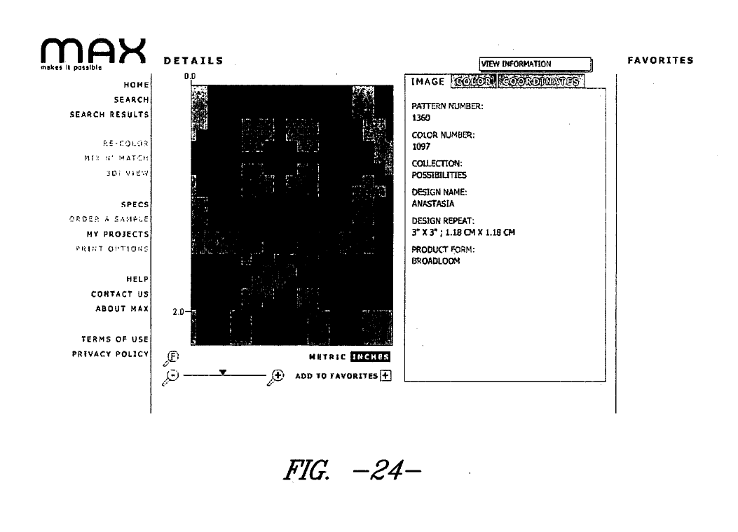

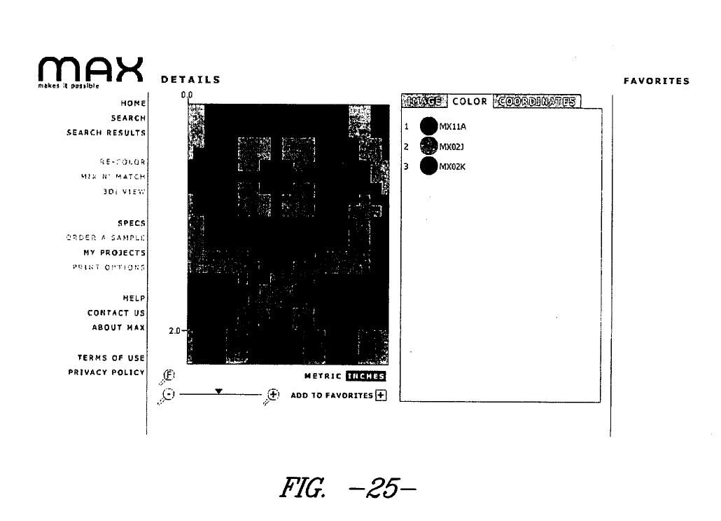

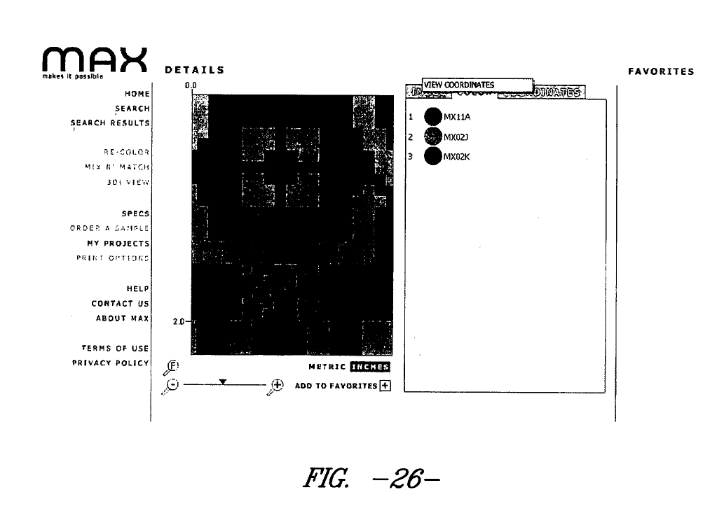

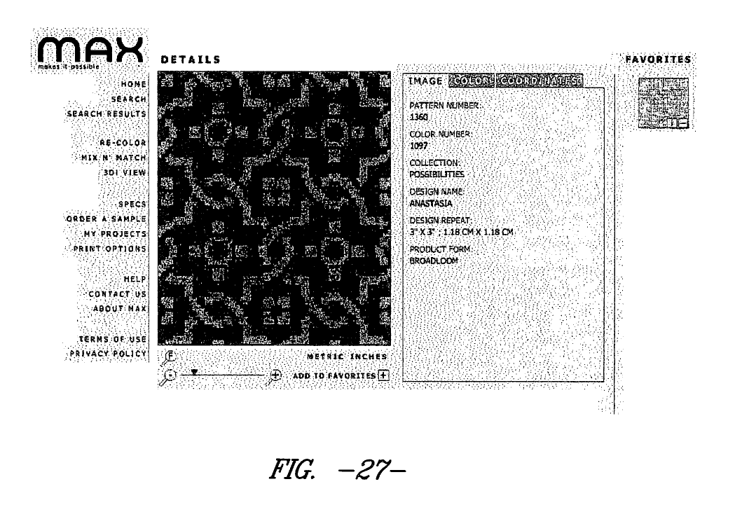

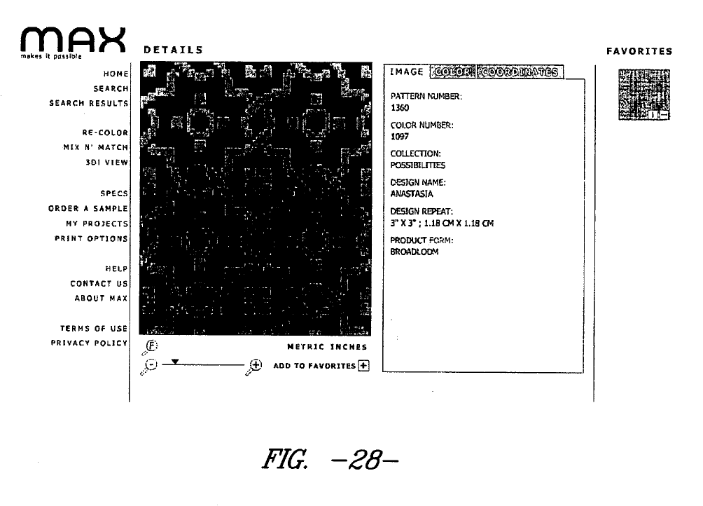

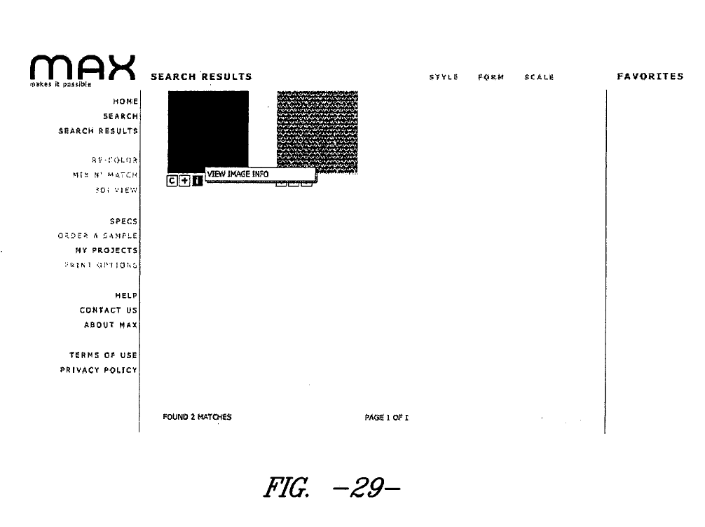

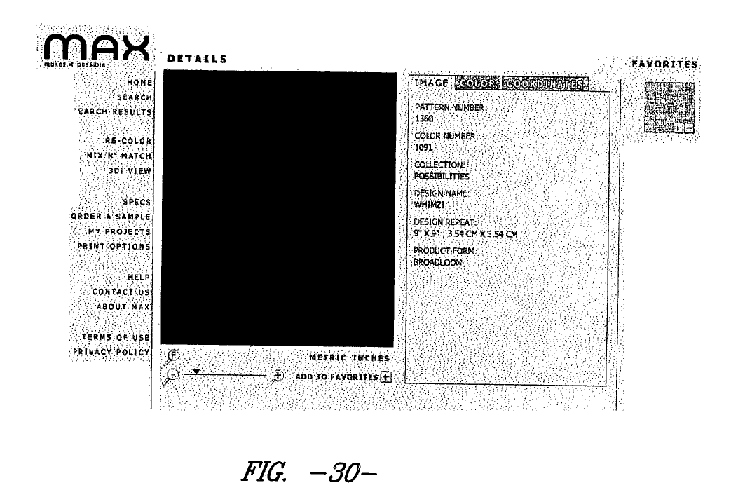

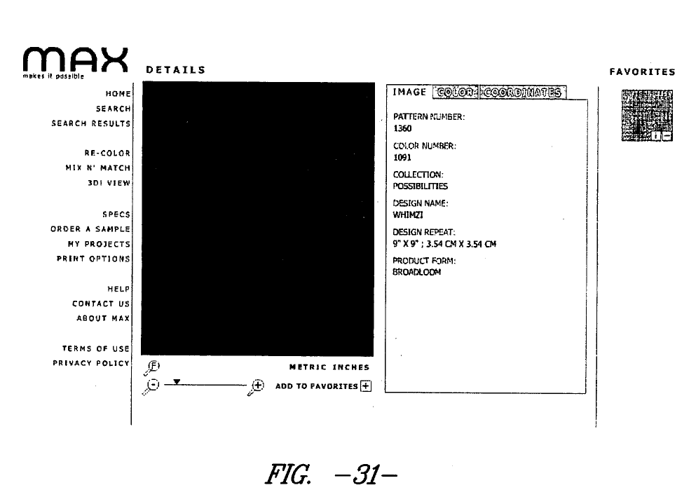

With reference to FIG. 2, an exemplary conventional carpet customer design review, selection, and ordering process may involve much time and effort on the part of the customer, a salesperson, and a designer.

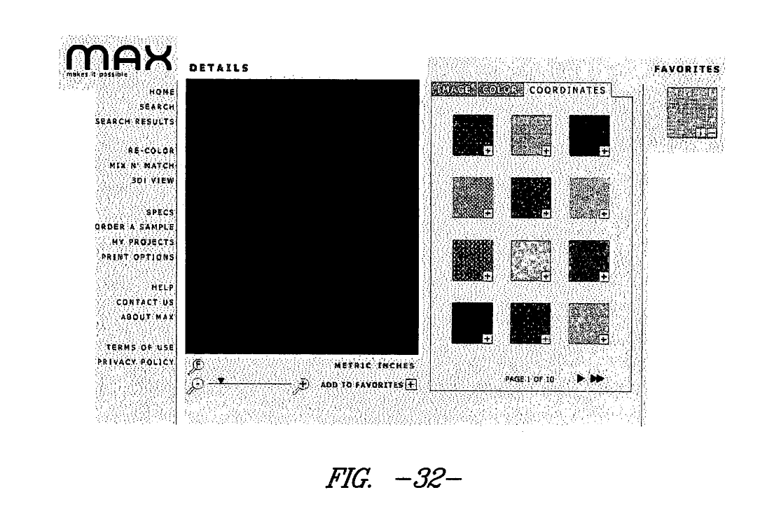

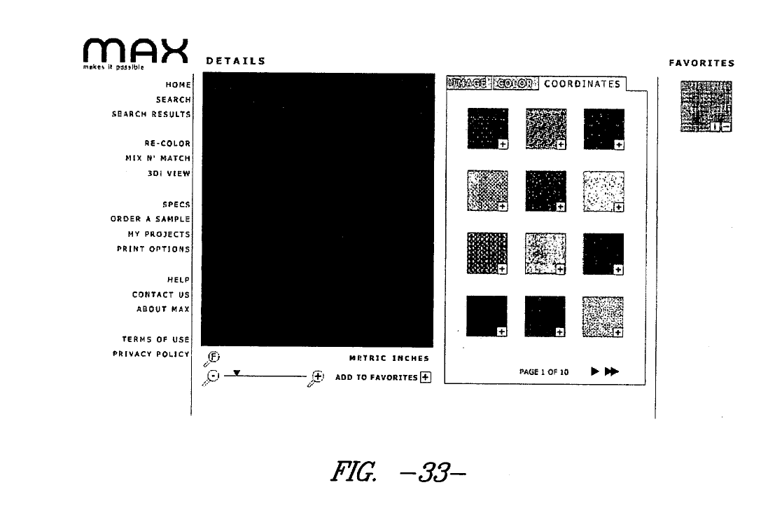

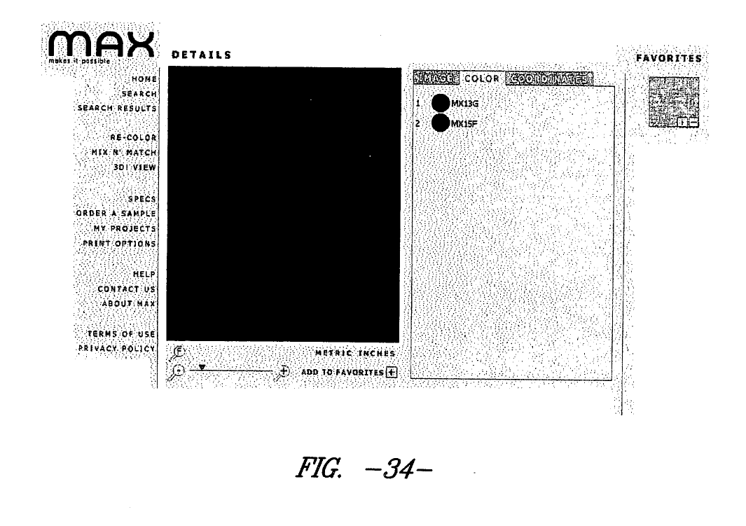

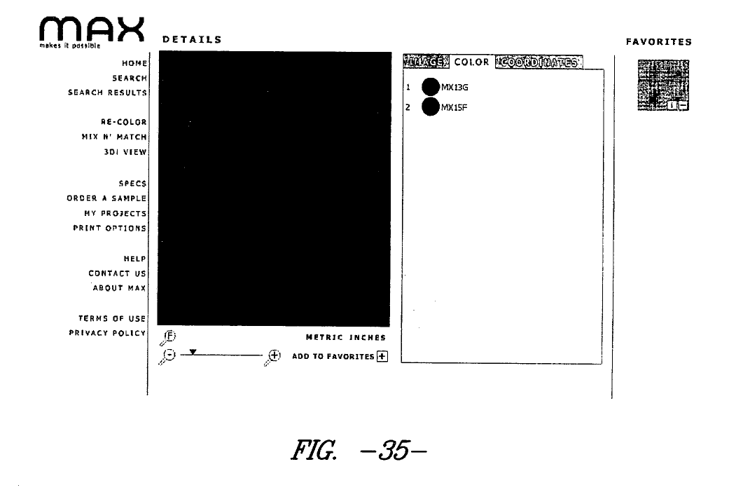

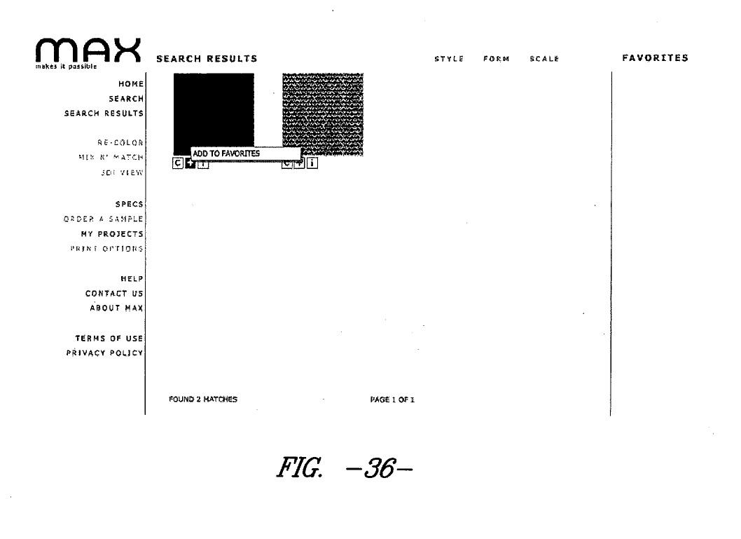

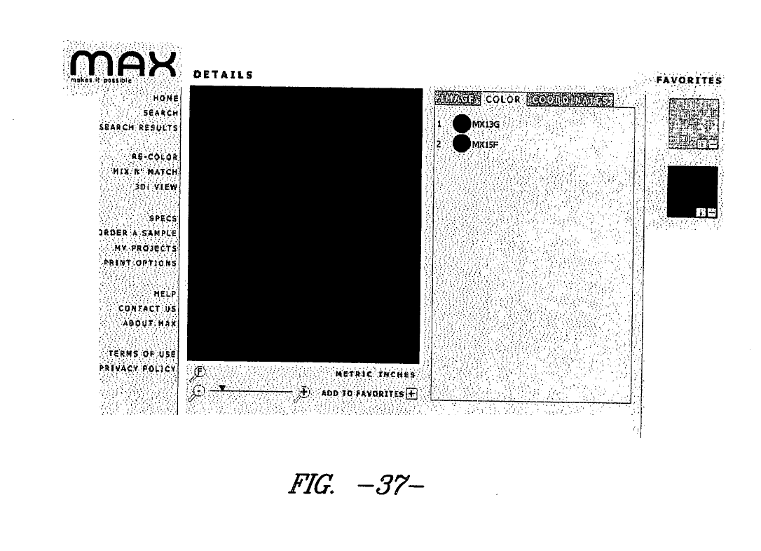

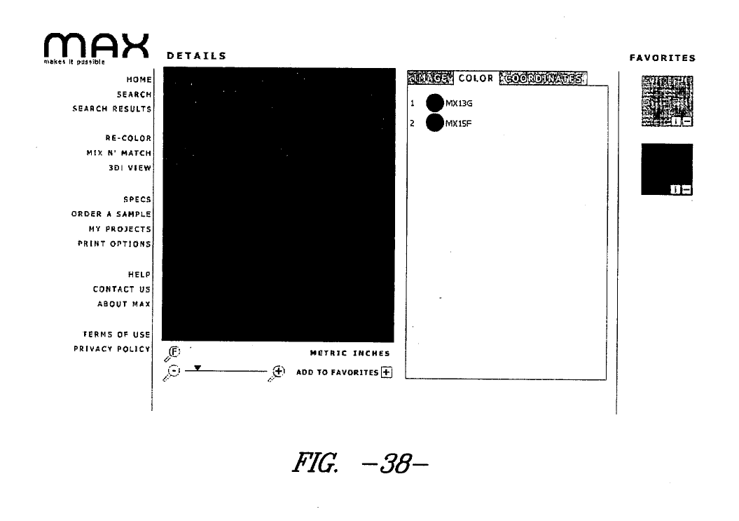

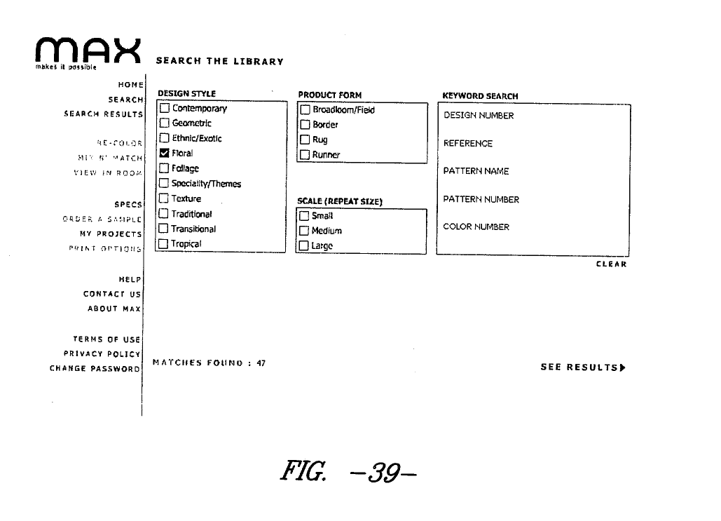

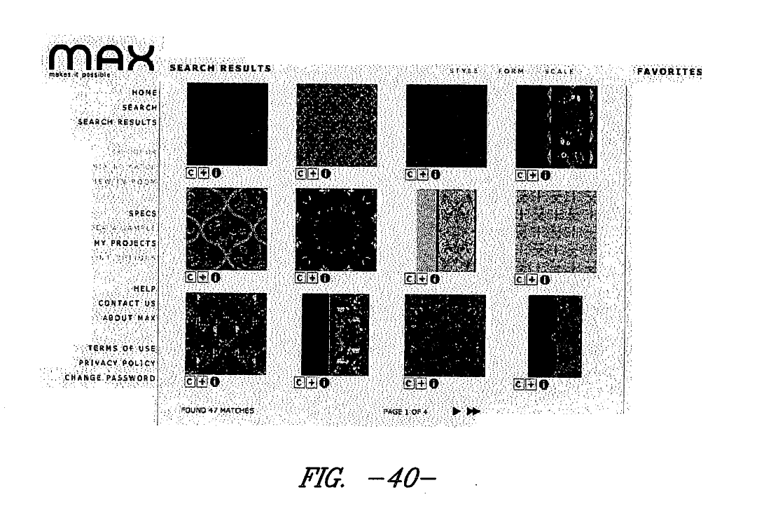

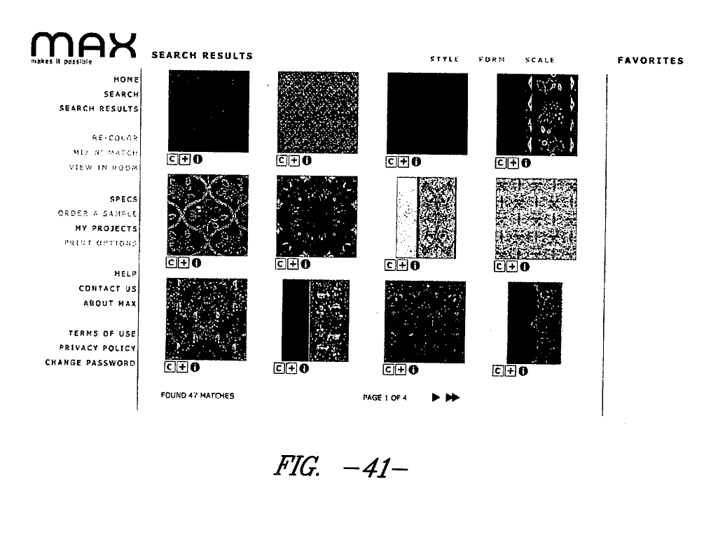

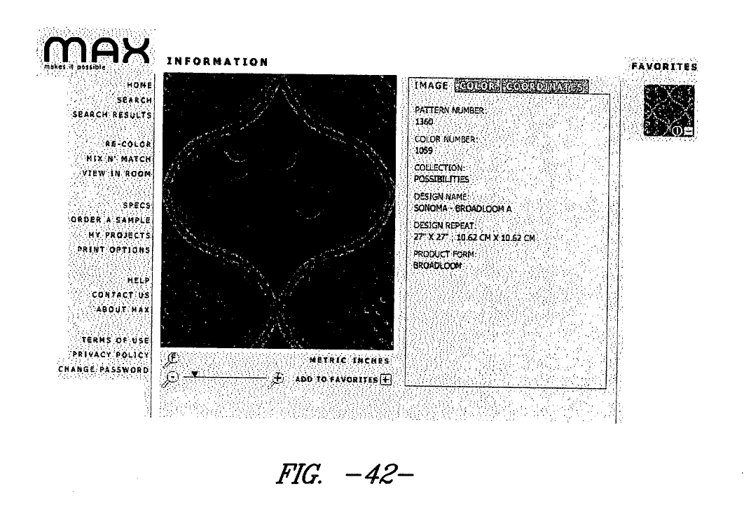

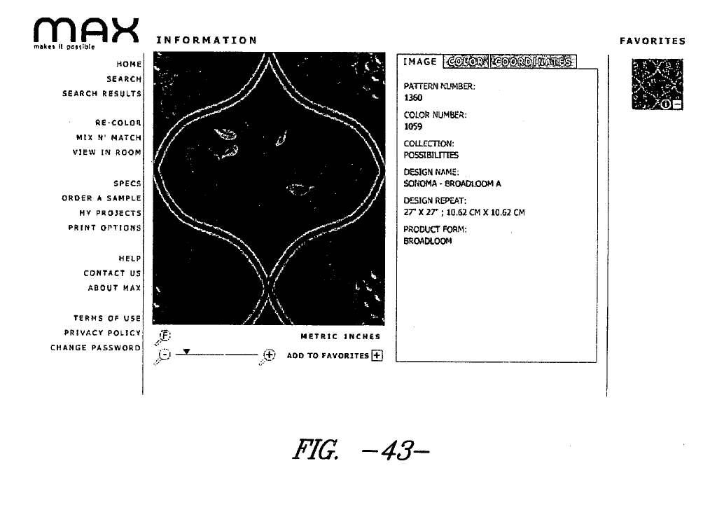

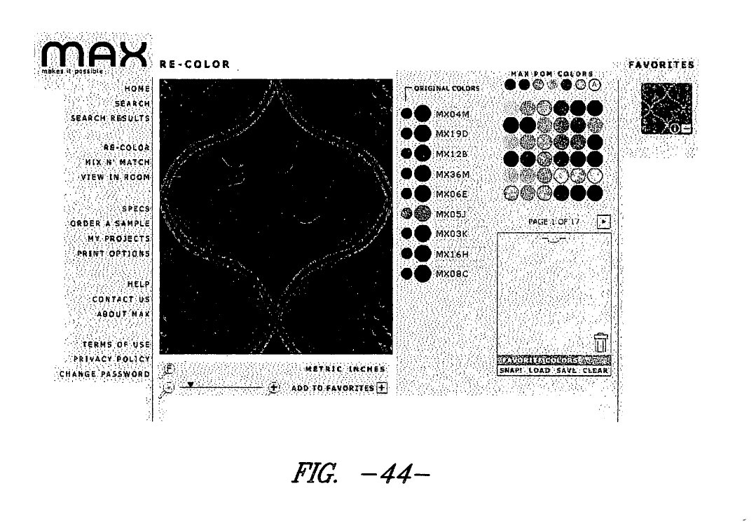

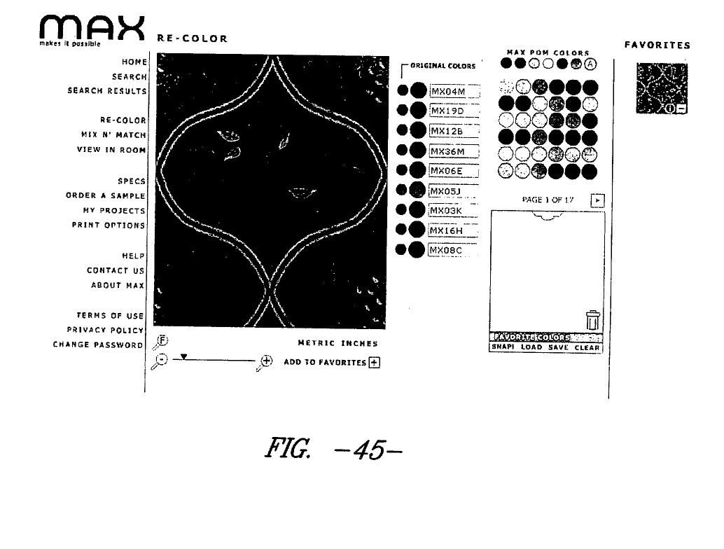

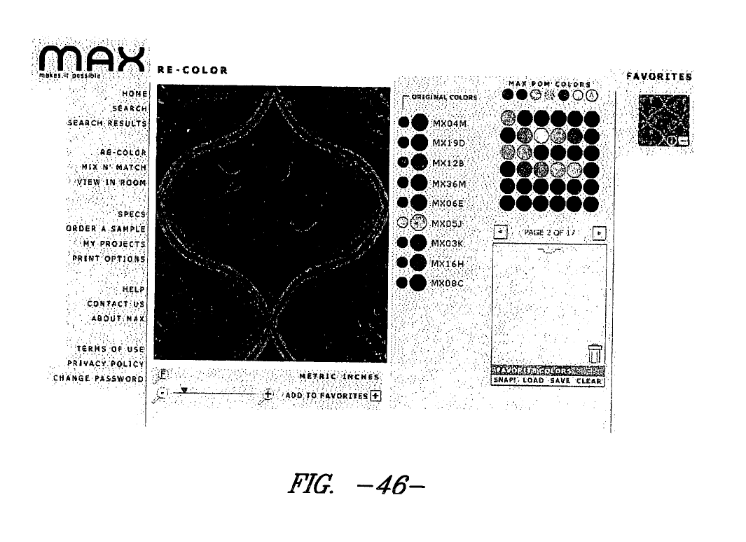

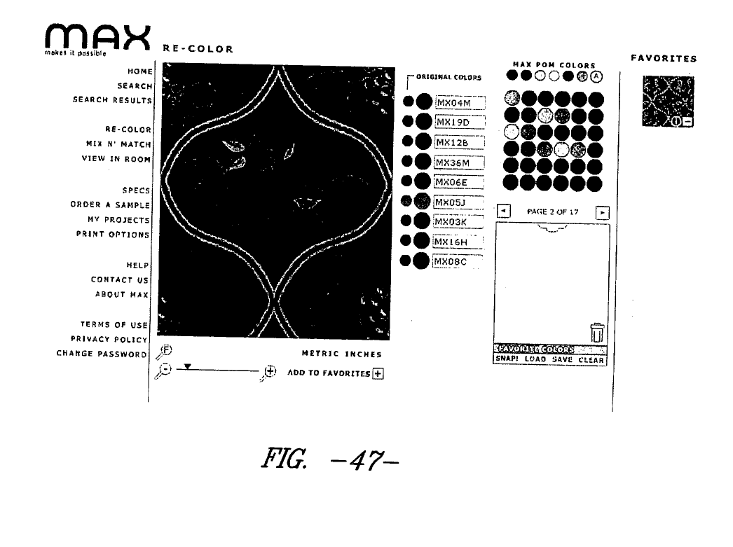

With reference to FIG. 3, an exemplary new carpet customer design review, revision, customization, and ordering system, method or process may reduce the time and effort involved and provide for a more favorable outcome (the customer gets a design that they selected and/or customized).

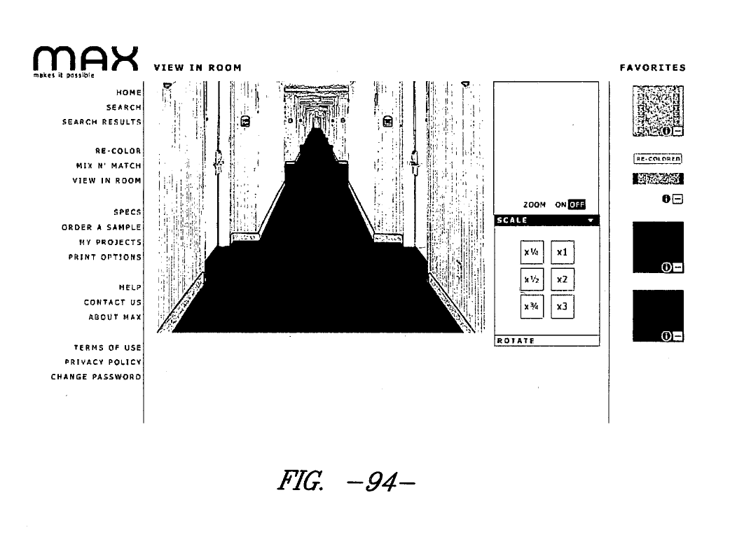

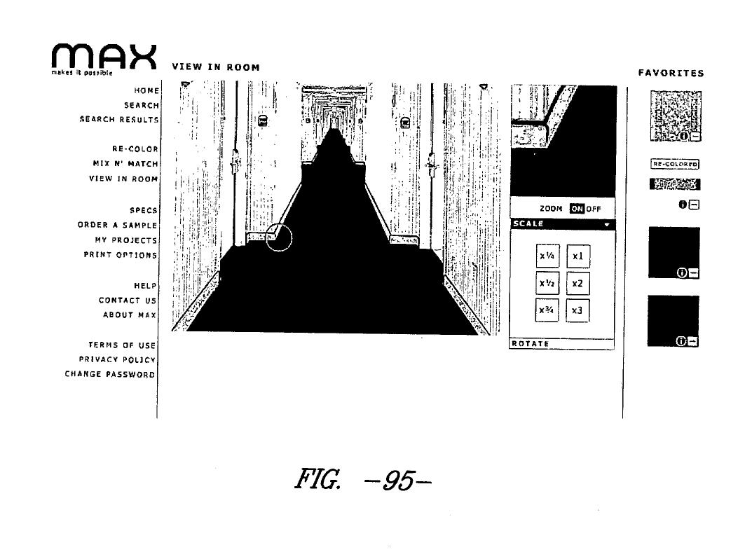

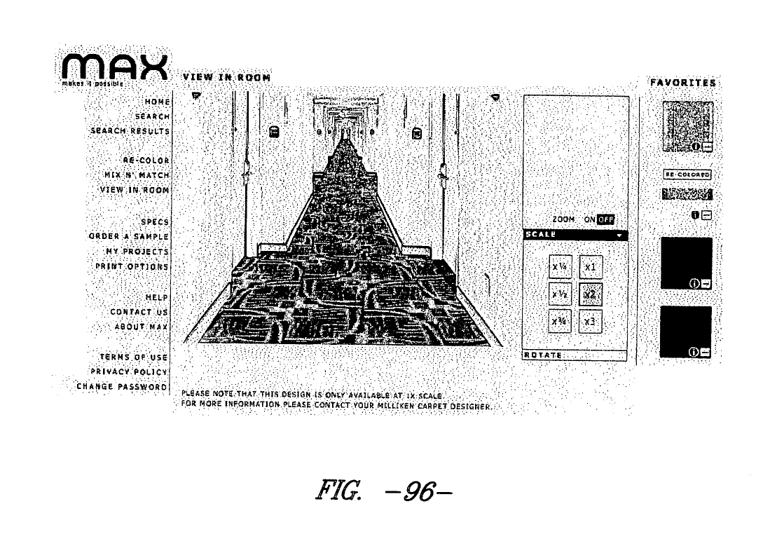

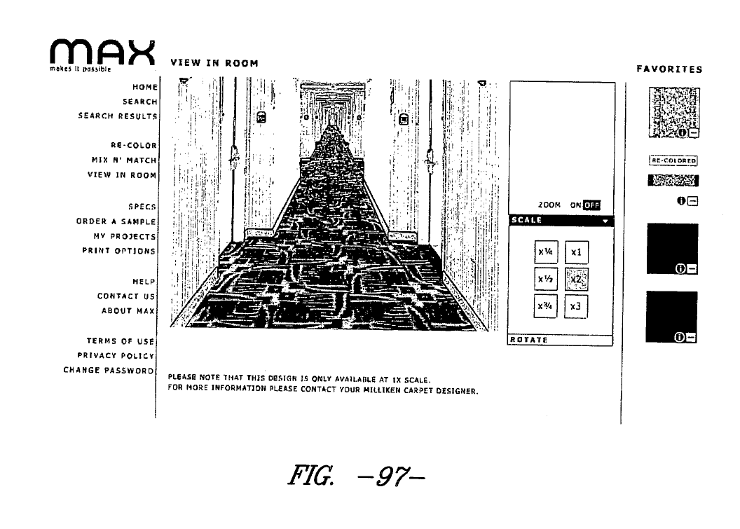

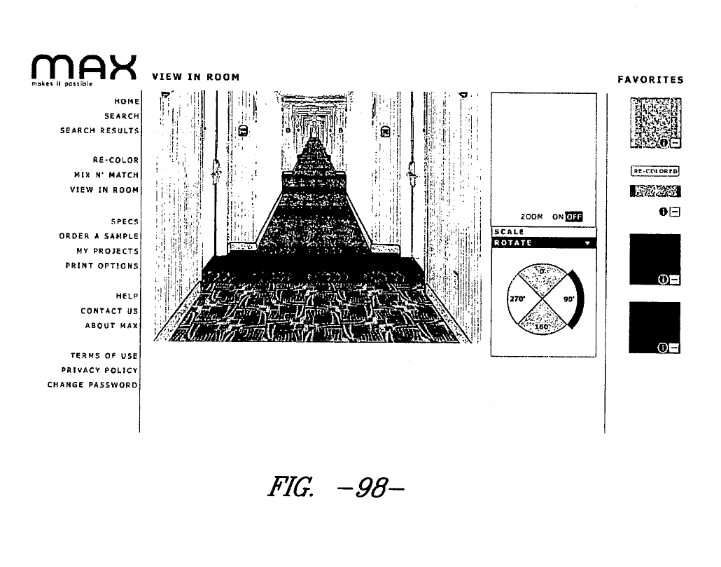

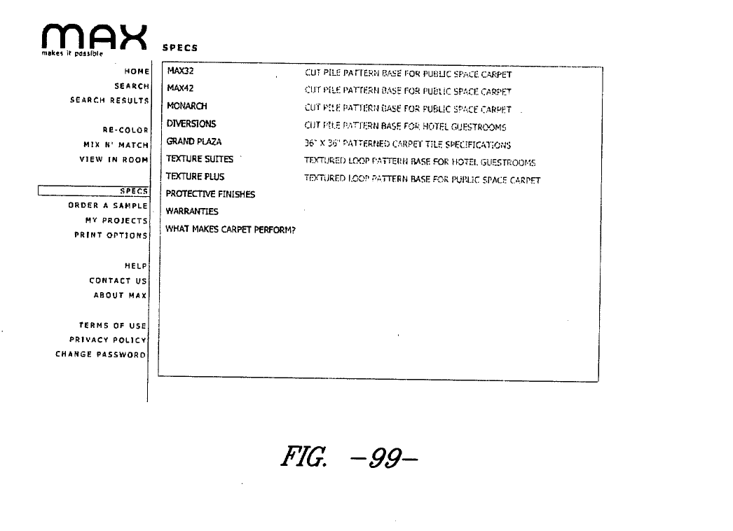

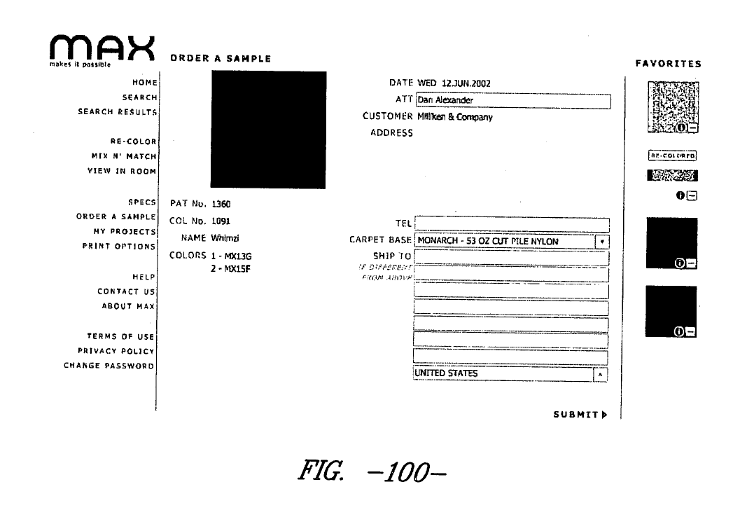

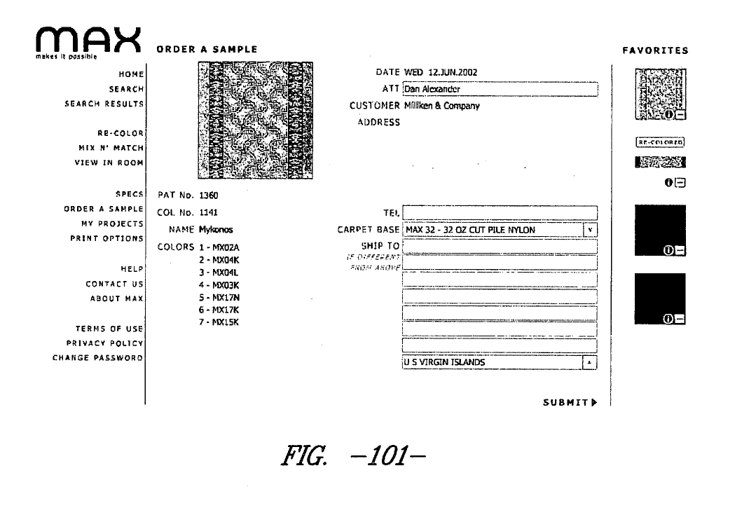

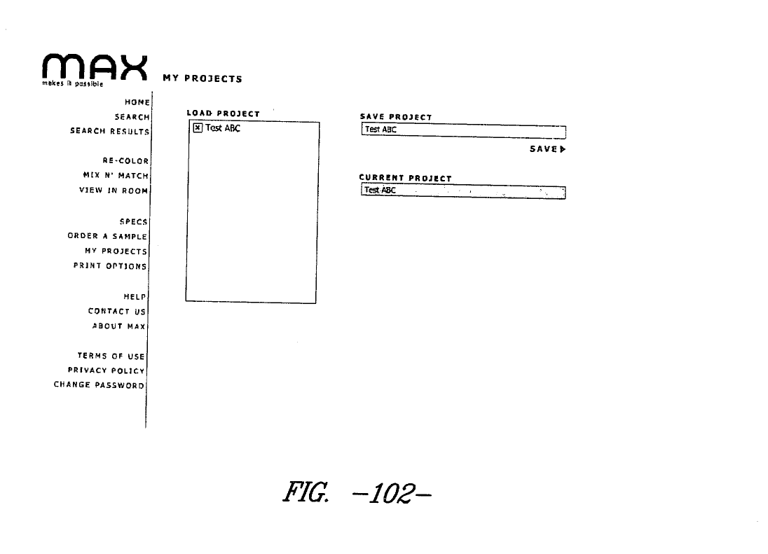

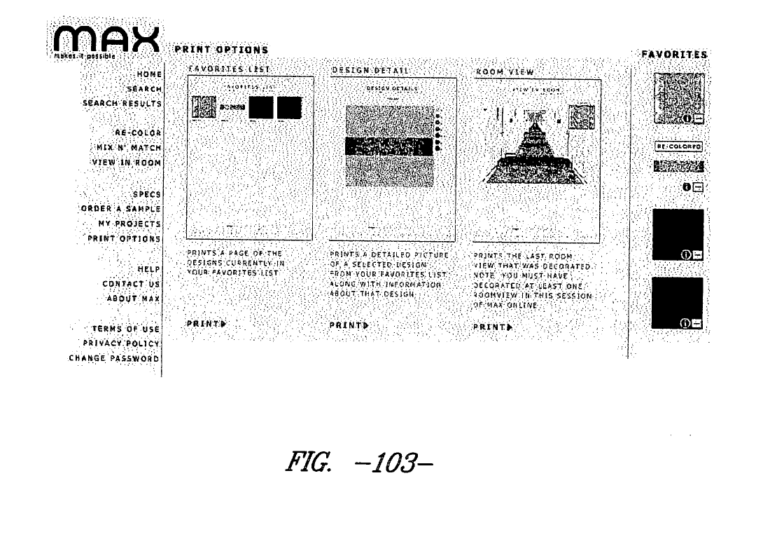

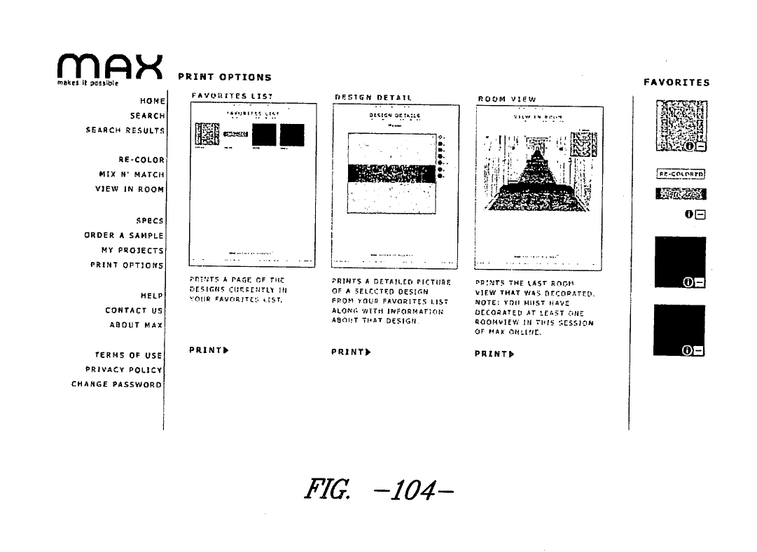

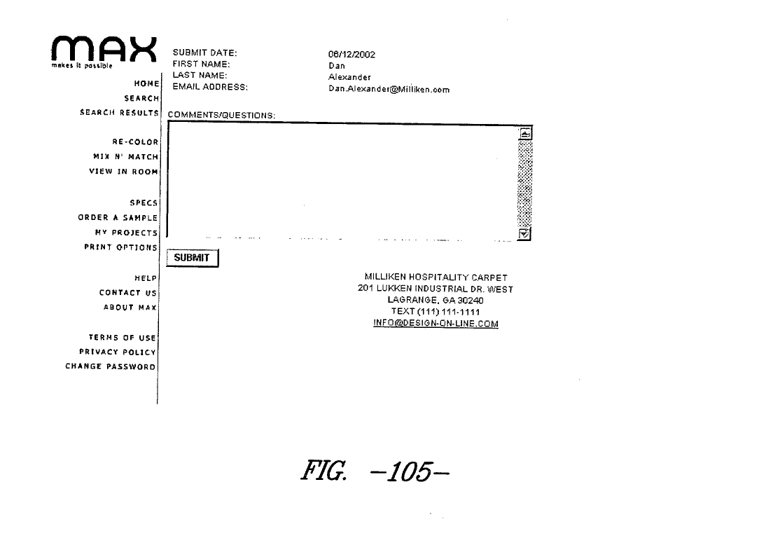

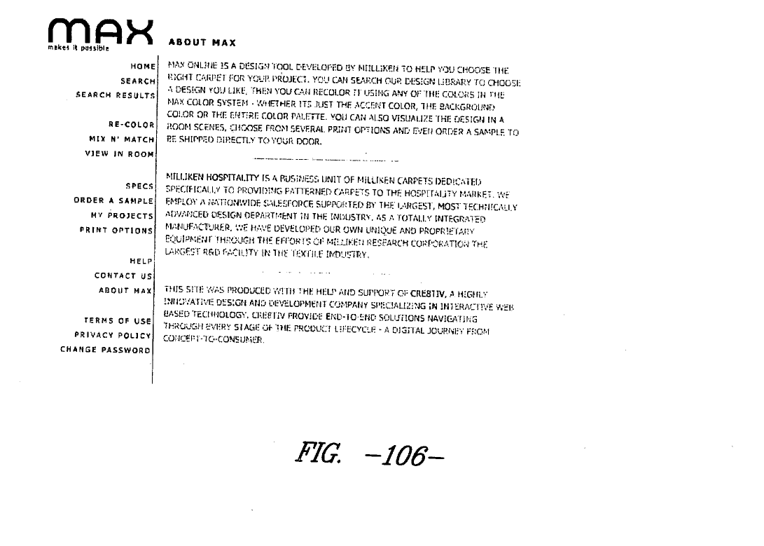

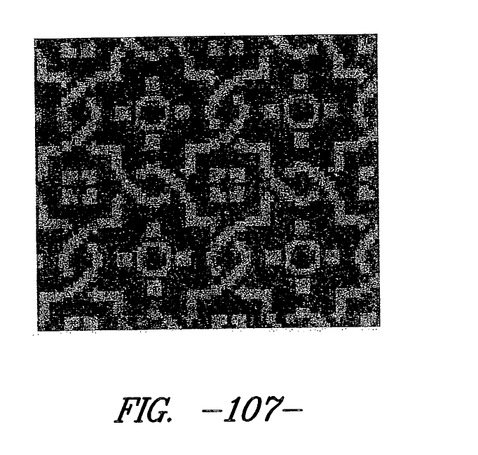

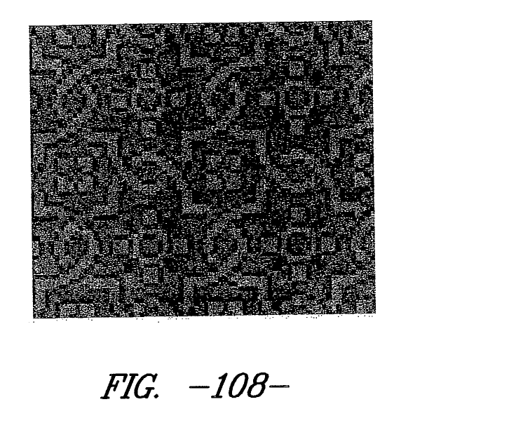

With reference to the particular example or embodiment of FIGS. 4-108, FIG. 4 is a representation of the opening screen display of an exemplary web site which the user clicks on to get to the search screen.

FIG. 6 is a representation of a screen display which a user uses to search for desired designs.

FIG. 7 is a representation of a particular search query for designs relating to contemporary design style, broadloom product, and with small scale repeat sizes.

FIG. 8 is a representation of a screen display of the results of the search query of FIG. 7 indicating that two designs were found and showing those designs in color and on a reduced scale from actual product.

FIG. 10 is a representation of a screen display showing that below each design the user may select a button to view coordinates of that design.

FIG. 11 is a representation of a screen display showing the coordinates of the first design.

FIG. 13 is a representation of a screen display showing that the user may view image information (details) on each of the coordinates.

FIG. 14 is a representation of a screen display showing that the user may get the latest version of each coordinate (add it to their favorites).

FIG. 15 is a representation of a screen display of the image information of the second coordinate from FIG. 11.

FIG. 17 is a representation of a screen display showing the Zoom to Fit functionality.

FIG. 18 is a representation of a screen display showing the Zoom Out functionality.

FIG. 19 is a representation of a screen display showing the design of FIG. 18 zoomed out as indicated by the inverted triangle next to the “−” button.

FIG. 20 is a representation of a screen display showing the Zoom In functionality.

FIG. 21 is a representation of a screen display showing the design of FIG. 20 zoomed out as indicated by the inverted triangle between the “−” and “+” buttons.

FIG. 22 is a representation of a screen display showing the ability to put metric measurements adjacent the design.

FIG. 23 is a representation of a screen display showing the ability to put inch measurements adjacent the design.

FIG. 24 is a representation of a screen display showing the option of viewing image information (details) in the box to the right of the design.

FIG. 25 is a representation of a screen display showing the ability to view the design colors in the box to the right of the design.

FIG. 26 is a representation of a screen display showing the option to view coordinates in the box to the right of the design (see FIG. 32).

FIG. 27 is a representation of a screen display showing the ability to add the design to the Favorites list by clicking on the Add to Favorites “+” button.

FIG. 29 is a representation of a screen display showing the View Image Information functionality.

FIG. 30 is a representation of a screen display showing the image information of the first (left-hand) design of FIG. 29.

FIG. 32 is a representation of a screen display showing the ability to view the coordinates of the design.

FIG. 34 is a representation of a screen display showing the ability to view the design colors.

FIG. 36 is a representation of a screen display showing the Add to Favorites functionality activated by the “+” button below the design.

FIG. 37 is a representation of a screen display showing the design added to the Favorites list.

FIG. 39 is a representation of a screen display showing a particular search query for floral design styles.

FIG. 40 is a representation of a screen display showing a first page of the results of the search of FIG. 39 (47 matches found in the exemplary database or archive of designs).

FIG. 42 is a representation of a screen display showing the image information of the fifth design (second down on the left) of FIG. 40 and with it added to Favorites.

FIG. 44 is a representation of a screen display (of the design of FIG. 42) showing the Re-Color functionality where the design colors are shown, the available color choices are shown, and giving a user the ability to change any or all of the design colors by selecting a new color from available colors.

FIGS. 46, 48, 50, 52, 54, 56, and 58 are respective representations of screen displays showing the first 8 pages of available colors of the design of FIG. 44.

FIG. 60 is a representation of a screen display showing the design of FIG. 44 recolored by changing the 9^{th} color (bottom color) by selecting a new color from page 17 of available colors.

FIG. 62 is a representation of a screen display showing the design of FIG. 44 recolored with two new colors for the 8^{th} and 9^{th} colors.

FIG. 64 is a representation of a screen display showing the design of FIG. 44 recolored by changing 3 of the colors.

FIG. 66 is a representation of a screen display showing the design of FIG. 44 recolored by changing 4 of the colors.

FIG. 68 is a representation of a screen display showing the design of FIG. 44 recolored by changing 5 of the colors.

FIGS. 60, 62, 64, 66, and 68 show the dramatic changes in the design caused by recoloring of the design. Once a user has developed (created) a new design (revised design) that meets their needs, they can save it to Favorites.

FIG. 70 is a representation of a screen display showing a particular search query for geometric design style, runner product, medium scale (repeat size).

FIG. 71 is a representation of a screen display showing the results of a search of FIG. 70 (3 matches found).

FIG. 73 is a representation of a screen display showing the image information of the first design of FIG. 71.

FIG. 75 is a representation of a screen display showing the Re-Color screen for the selected design of FIG. 73.

FIG. 77 is a representation of a screen display showing the ability to recolor (change) the last color by clicking on the large color dot and then clicking on the new color dot from the available colors (color palette).

FIG. 78 is a representation of a screen display showing the last color (bottom most) having been changed (recolored) in the design of FIG. 75.

FIG. 80 is a representation of a screen display showing 5 of the colors having been changed in the design of FIG. 75.

FIG. 82 is a representation of a screen display showing the ability to save Favorite Colors in the box below the available colors (by dragging each one to the box).

FIG. 84 is a representation of a screen display showing the recolored design added to the Favorites list.

FIG. 85 is a representation of a screen display showing the Mix N' Match functionality of selecting different designs for the Outfill, Border, and Broadloom/Field.

FIG. 87 is a representation of a screen display showing one of the designs from the Favorites list selected as the Outfill.

FIG. 88 is a representation of a screen display showing one of the Favorites list designs selected as the Border.

FIG. 89 is a representation of a screen display showing all three designs selected from the Favorites list as Outfill, Border and Broadloom, respectively to provide visualization of the selected layout or combination.

FIG. 91 is a representation of a screen display showing the Choose a Room (room scene) functionality.

FIG. 92 is a representation of a screen display showing a selected room scene (the first one) from FIG. 91.

FIG. 93 is a representation of a screen display showing the room scene of FIG. 92 with a selected design from the Favorites list.

FIG. 95 is a representation of a screen display showing the Zoom functionality (area in the circle is zoomed and shown in the Zoom box).

FIG. 96 is a representation of a screen display showing a different design selected for the room scene and scaled at 2 times usual scale.

FIG. 98 is a representation of a screen display of the design of FIG. 96 rotated 90°.

FIG. 99 is a representation of a screen display showing the Specs information for a selected design.

FIG. 100 is a representation of a screen display showing the Order a Sample functionality for ordering a selected design from the Favorites list.

FIG. 101 is a representation of a screen display showing another example of an Order a Sample screen.

FIG. 102 is a representation of a screen display showing the My Projects functionality. This may show projects for a particular user or organization.

FIG. 103 is a representation of a screen display showing the Print Options functionality.

FIG. 105 is a representation of a screen display showing the Contact Us functionality.

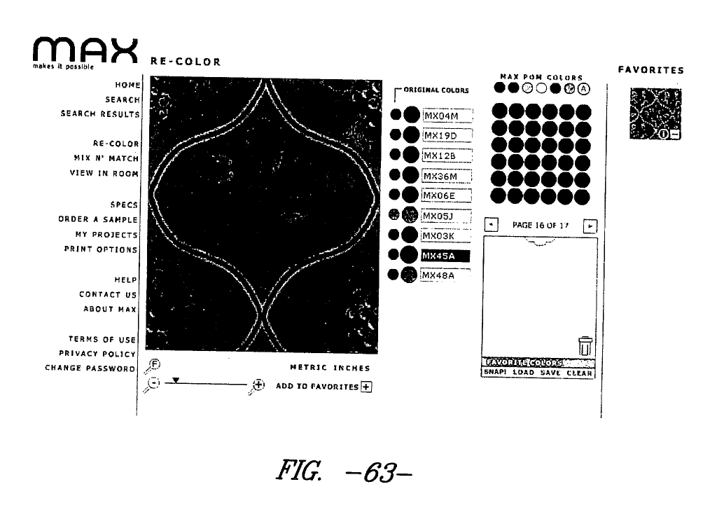

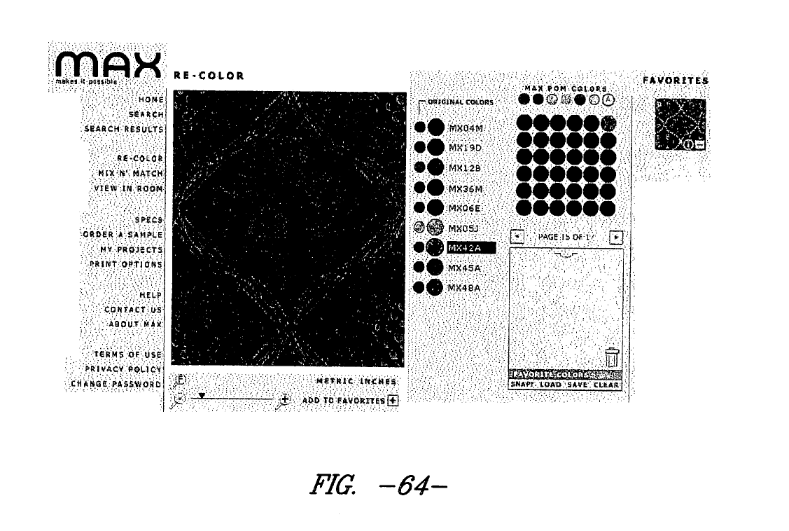

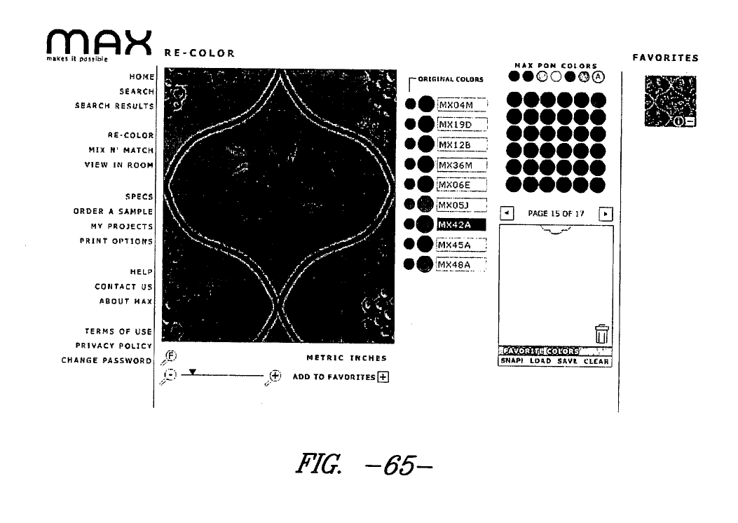

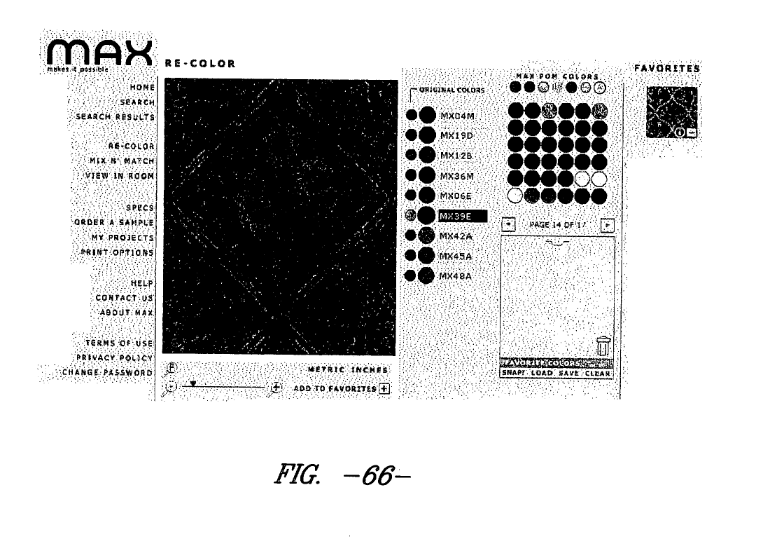

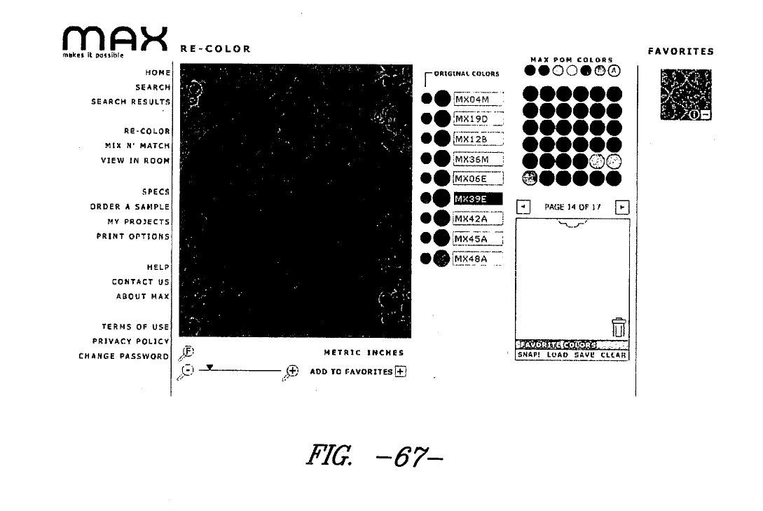

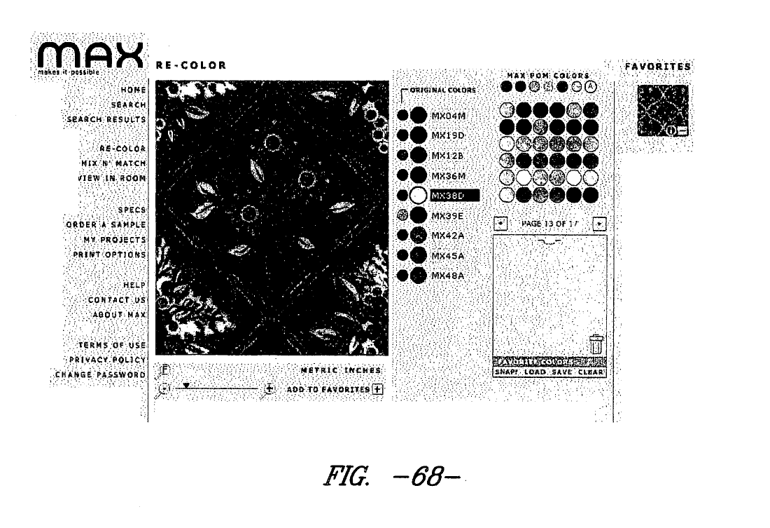

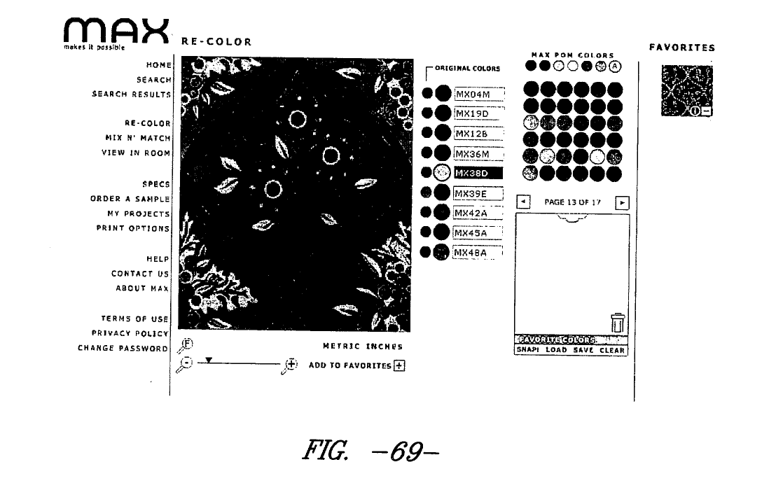

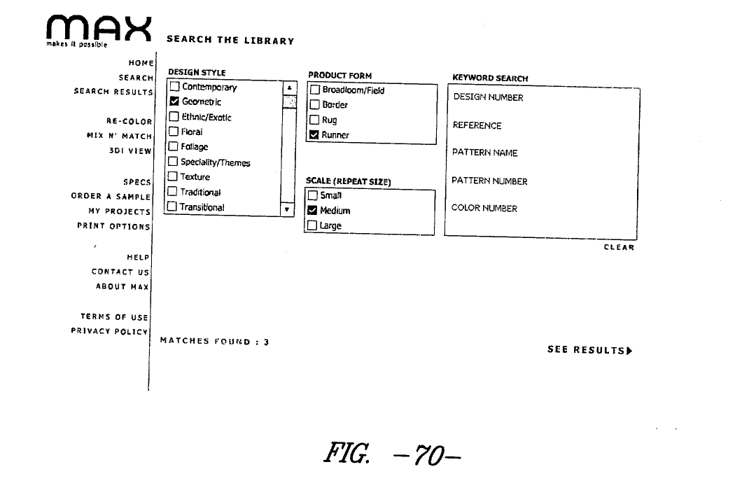

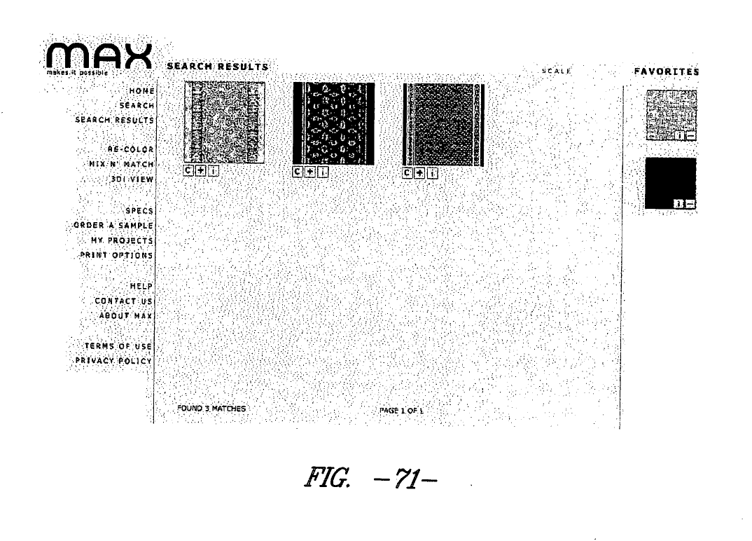

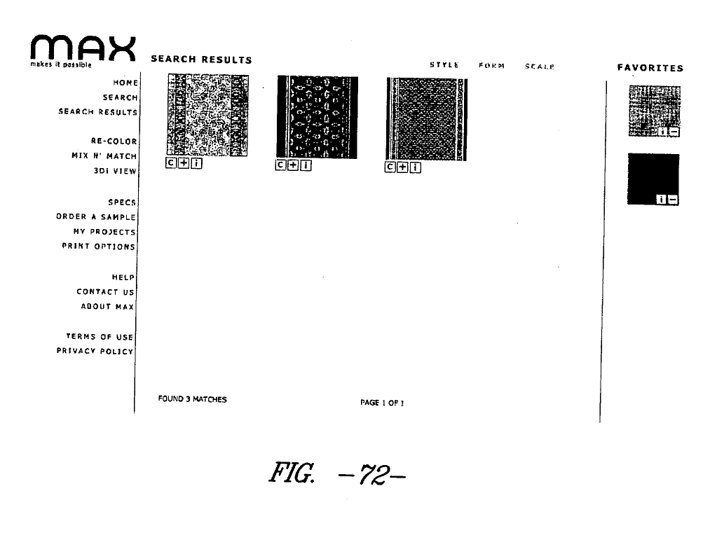

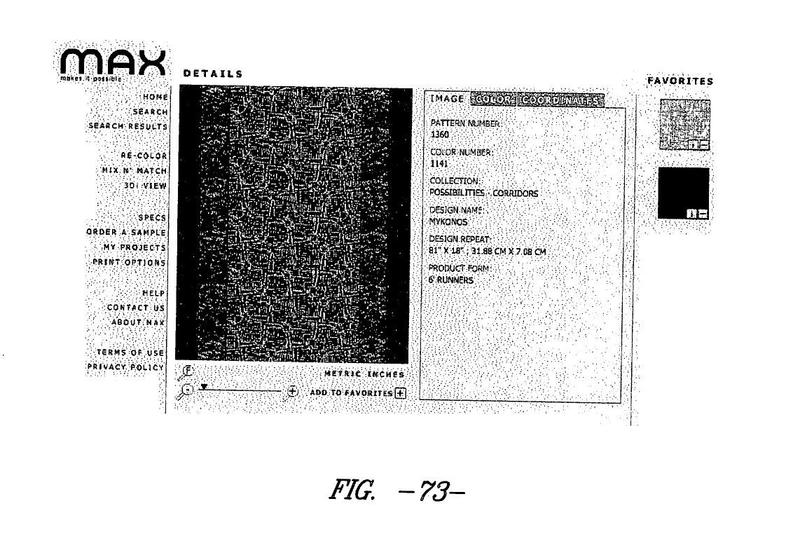

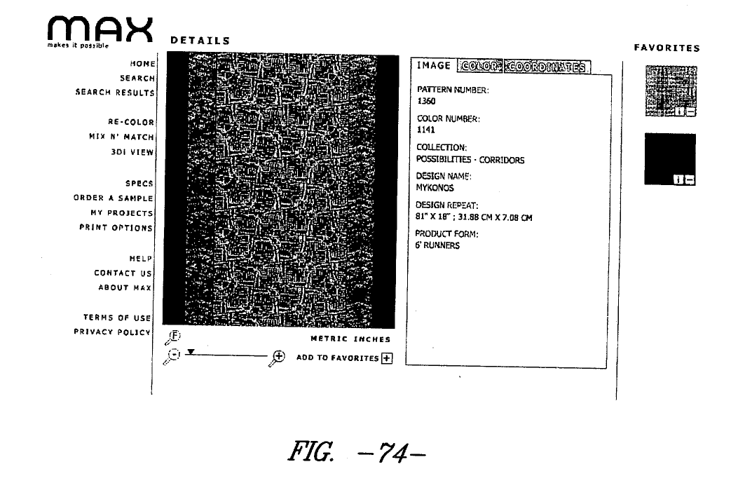

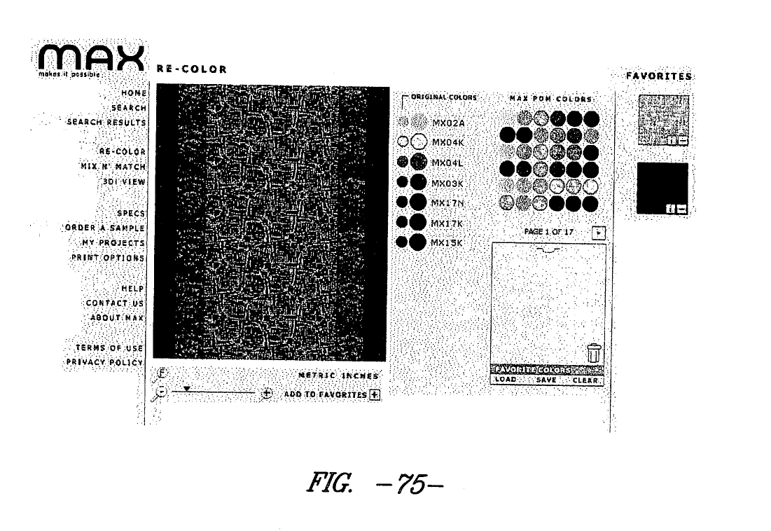

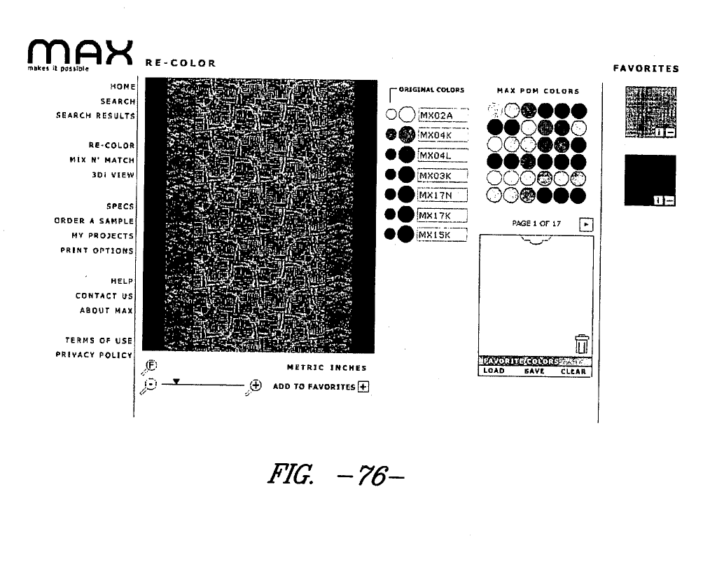

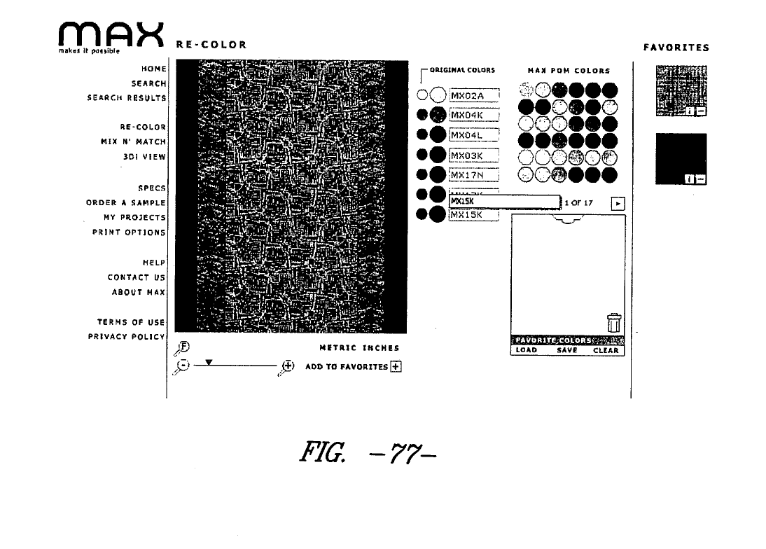

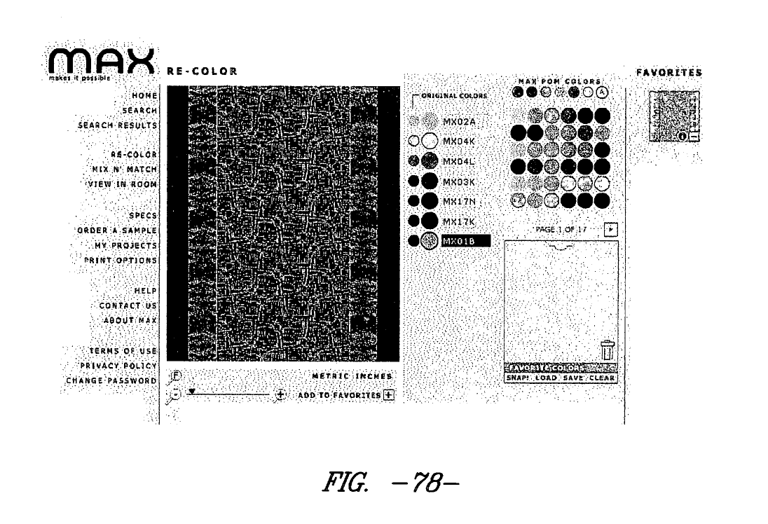

FIG. 106 is a representation of a screen display of the About Max screen.

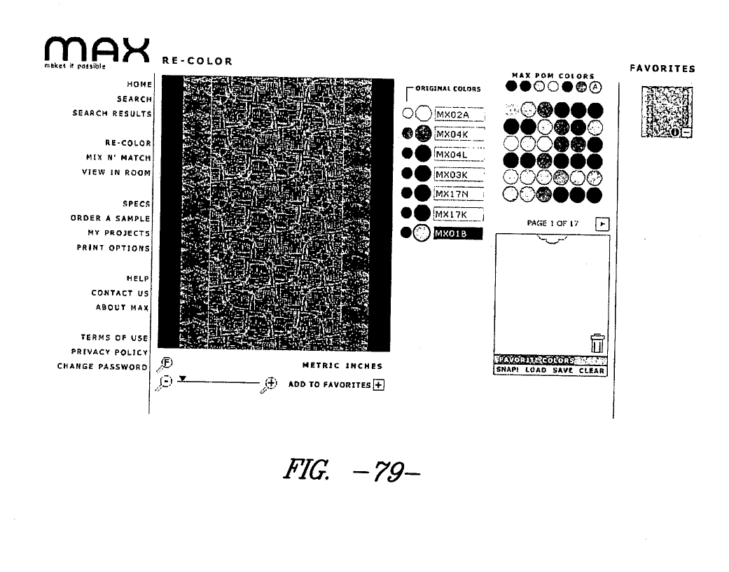

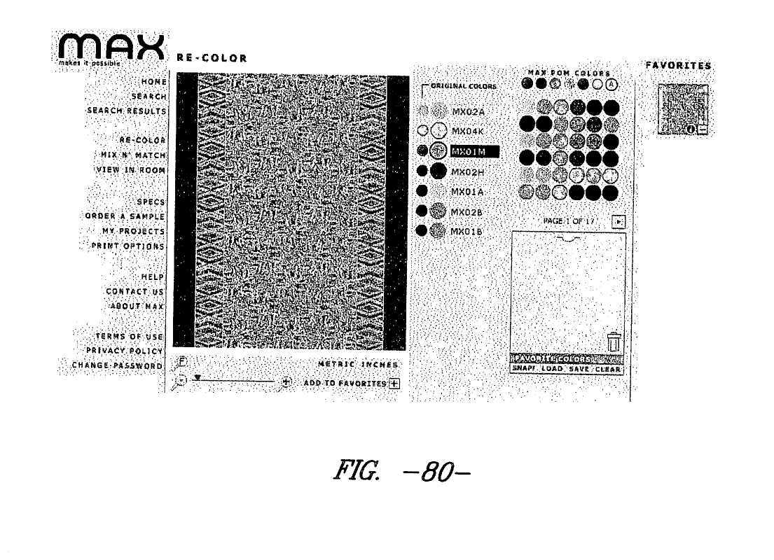

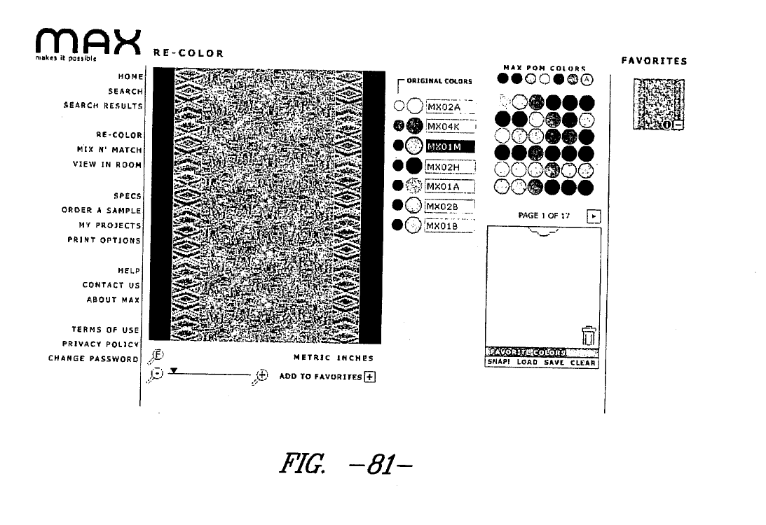

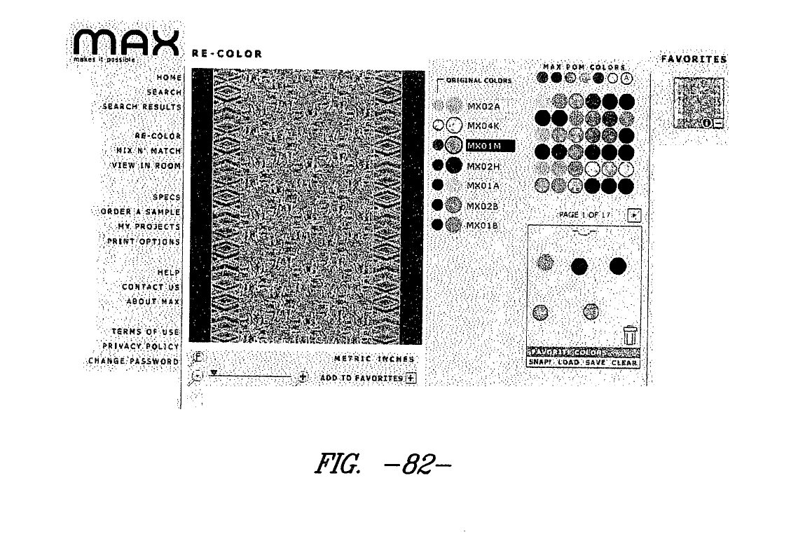

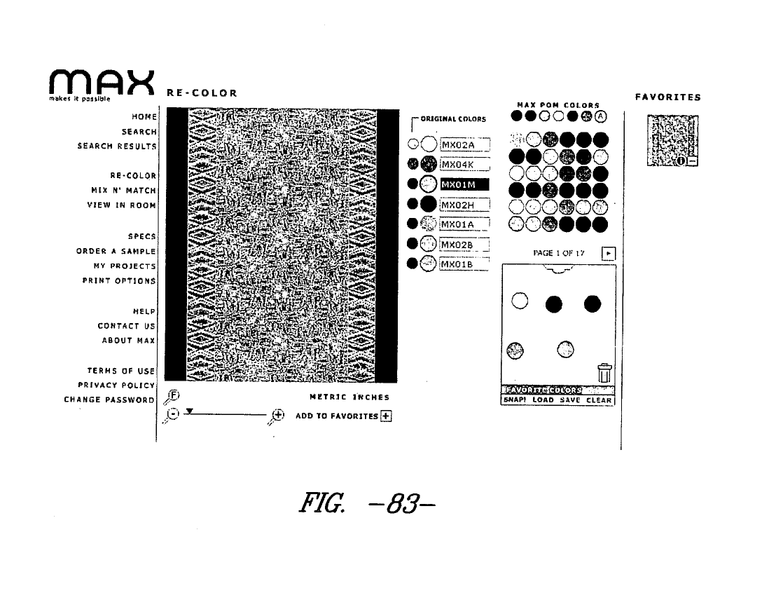

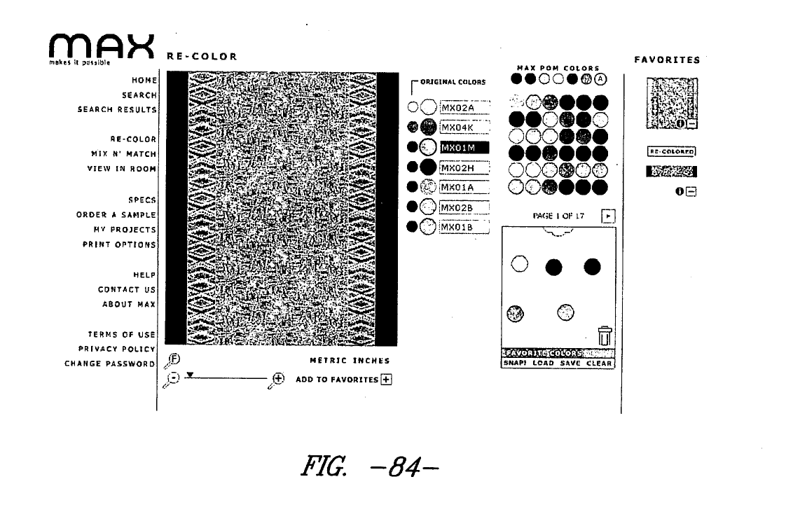

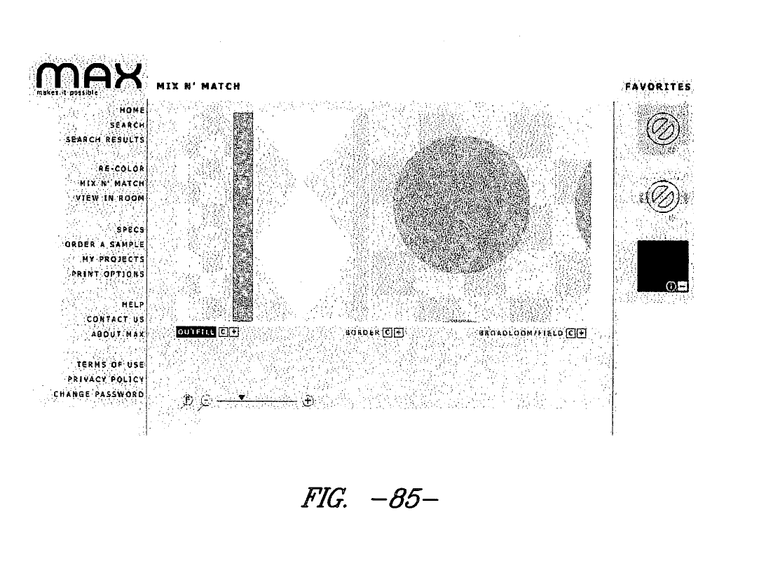

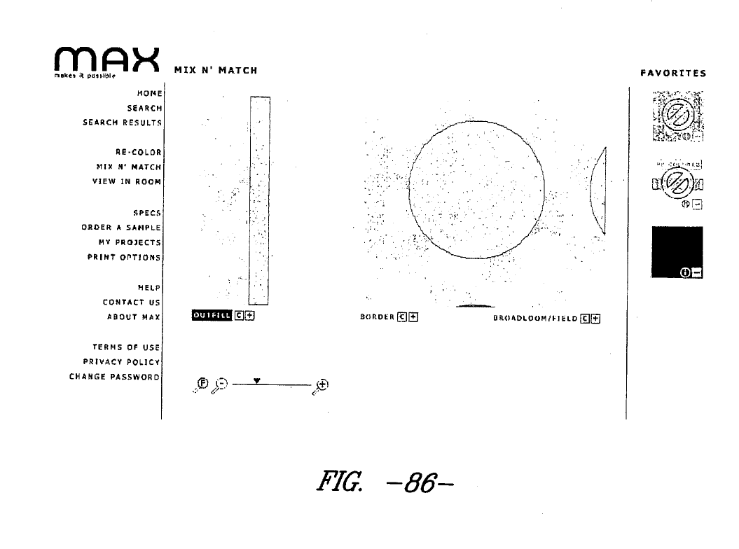

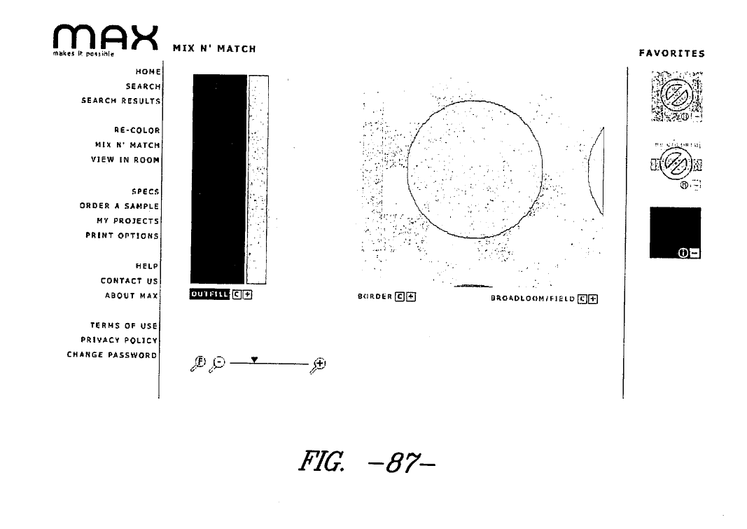

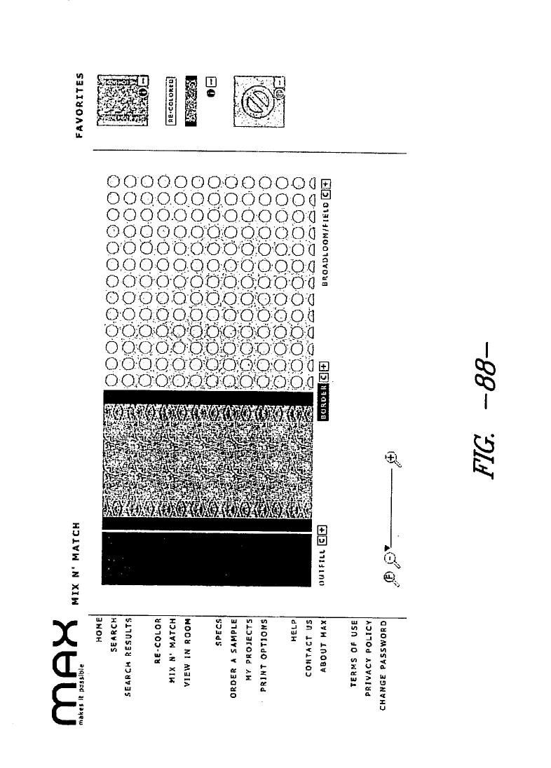

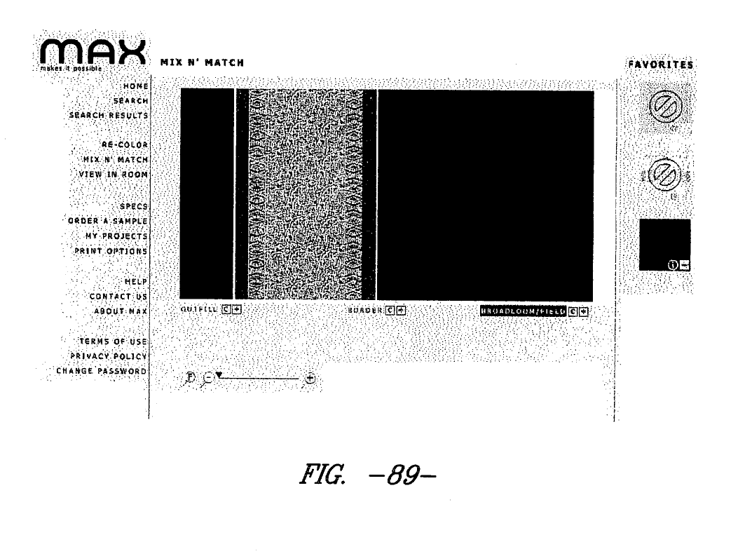

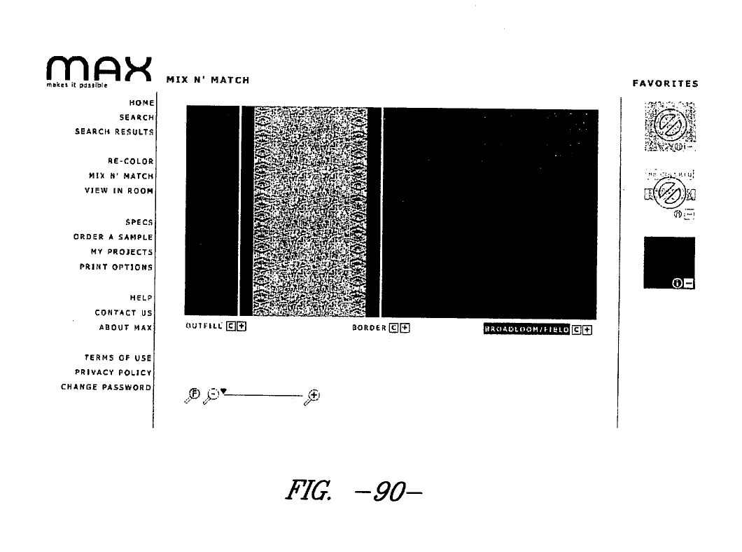

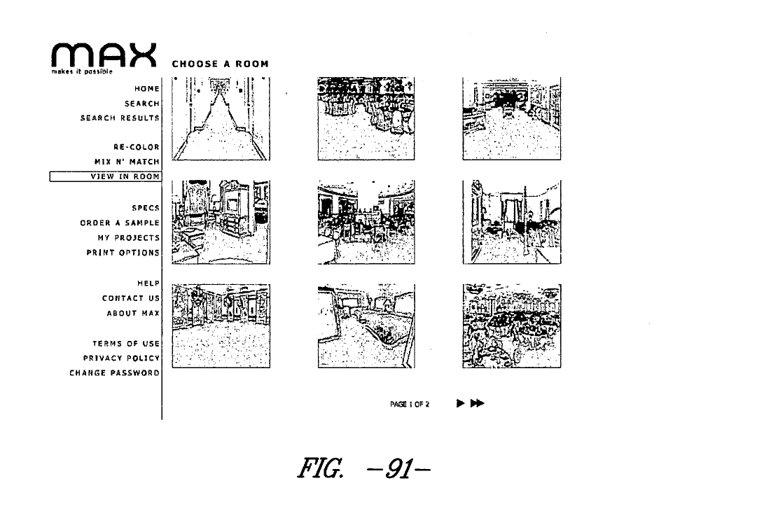

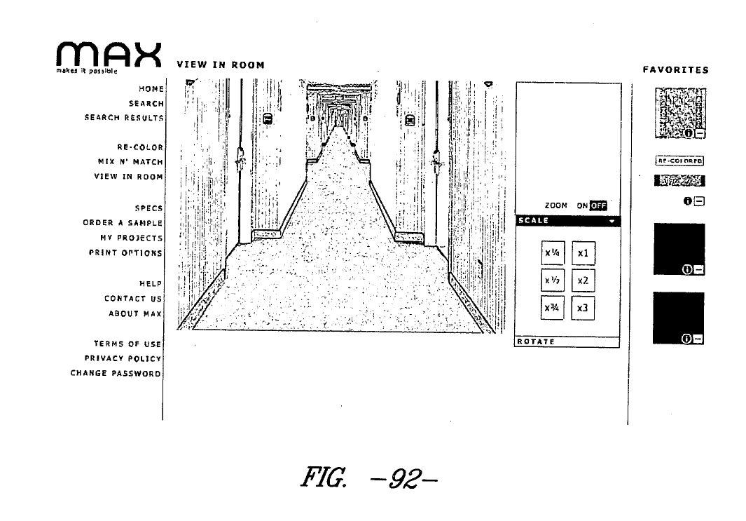

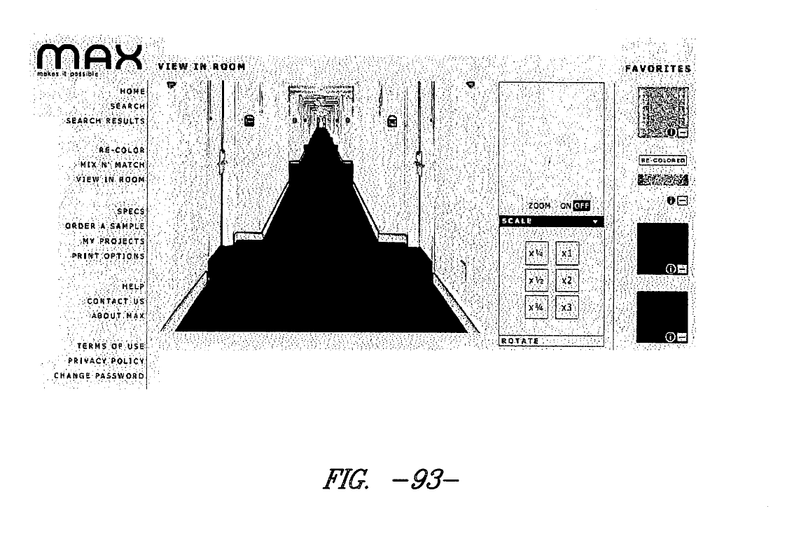

FIG. 107 is a representation of a product produced by the system or method of FIGS. 4-106, such as a patterned carpet product having an offered, revised, or recolored design thereon.

In accordance with the example of FIGS. 4-106, the present invention facilitates the selection of the appropriate floor covering for a particular project. More particularly, using the present system a user may search a design library to choose a desired design and then recolor that design using any of numerous predefined colors in the system. The present system also permits a user to visualize the design in a room scene, choose from several print options and even order a sample for shipment.

As will be appreciated, while the invention has been illustrated and described herein with reference to certain embodiments, practices and procedures, these embodiments, practices and procedures have been presented by way of example only and in no instance are to be construed as in any way limiting the scope of the invention. Rather, it is contemplated that modifications and variations embodying the principles of this invention may likely occur to those of skill in the art. It is thus contemplated and intended that the present invention shall extend to all such modifications and variations as may incorporate the broad aspects of the invention within the true spirit and scope of the appended claims and all equivalence thereto.

1. A method of producing a sample of floor covering material, the method comprising:
providing a library of electronically stored original images of floor covering patterns grouped in a plurality of searchable categories defined by the content of the patterns, wherein at least a portion of said floor covering patterns include a plurality of segments of different colors;
providing a computer controlled internet-based interactive communications site adapted to communicate with a multiplicity of users such that said users may access and search said library of electronically stored original images, wherein at least a portion of said electronically stored original images are adapted to be manipulated by said users through said communications site such that at least a portion of the segments of different colors may be recolored by said users using colors from a pallet of predefined available colors to generate recolored images of floor covering patterns, and wherein said original images and said recolored images are adapted to be arranged in an electronic format to form multiple pattern floor covering images;
communicating at least one print image selected from the group consisting of said original images of floor covering patterns, said recolored images of floor covering patterns and said multiple pattern floor covering images to a printing device; and
printing said print image on the surface of a floor covering material using said predefined available colors.

2. The invention as recited in claim 1, wherein said users are preselected.

3. The invention as recited in claim 1, including the further step of alerting said users when new designs are available for review.

4. The invention as recited in claim 3, wherein the alerting step comprises communication through an e-mail delivery system.

5. The invention as recited in claim 1, wherein said electronically stored original images of floor covering patterns are adapted to be electronically communicated as printable web documents to computers operated by said users.

6. The invention as recited in claim 5, wherein said printable web documents include embedded print commands activatable by said users.

7. The invention as recited in claim 1, further comprising the step of providing means for said users to communicate in real time on-line with a designer.

8. A computer based system for simulating actual floor covering designs, the system comprising:
a computer system including a processor, a user interface and a display device; and
a plurality of manipulatable simulated floor covering design elements, each representing a pattern corresponding to a pattern of at least one prospective actual floor covering element, said simulated design elements being independently manipulatable via said user interface such that at least a portion of said simulated design elements may be recolored by said users using colors from a pallet of predefined colors, and said simulated design elements being displayed on said display device upon recoloring by said users.

9. The system as recited in claim 8, wherein said simulated design elements comprise digital files.

10. The system as recited in claim 9, wherein the display device is a CRT display or computer monitor.

11. The system as recited in claim 9, wherein at least two of said simulated design elements may be arranged relative to one another in an electronic format to simulate a border pattern adjacent to an interior pattern.

12. The system as recited in claim 9, wherein said simulated design elements are adapted to be communicated to a printing apparatus for printing of a sample of floor covering material.
